(19) United States
(12) Patent Application Publication
(10) Pub. No.: US 2012/0123953 A1
(43) Pub. Date: May 17, 2012

(54) METHODS AND SYSTEMS FOR ASSESSING THE ENVIRONMENTAL IMPACT OF A PRODUCT

(76) Inventor: John F. Jabara, Bethesda, MD (US)

(21) Appl. No.: 12/947,607

(22) Filed: Nov. 16, 2010

(51) Int. Cl. G06Q 99/00

(52) U.S. Cl. 705/317

(57) ABSTRACT

Embodiments consistent with this disclosure provide systems and methods for analyzing manufactured products and more particularly, for combining laboratory analysis with life cycle analysis to assess manufactured products with respect to the products' impact on the environment. Systems and methods consistent with this disclosure may produce assessment results in the form of an information label, score, report, or rating, characterizing the environmental impact of a product over its life cycle.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This application relates generally to analyzing manufactured products and more particularly, to combining laboratory analysis with life cycle analysis to assess manufactured products with respect to the products' impact on the environment.

### BACKGROUND

A growing number of consumers around the world want to know the environmental impact of the products they own or are planning to purchase. This is particularly true among young consumers age 25-35, but is increasingly true across all age groups in line with growing public awareness, education, and mass media coverage of global warming, environmental disasters and other environmental issues. Most consumers, if price and performance are approximately equal for a given type of product, will choose the more environmentally friendly alternative.

With growing public awareness, a new need is currently emerging in that consumers want to know more than one or two superficial environmental characteristics of a product, such as a single energy use rating. Instead, they are interested in many aspects of environmental performance, such as toxic chemical use, recyclability, and other attributes that reflect the entire life cycle environmental impact of the product. For example, depending on the product type and consumer's usage of a product, material or transportation may be more important than energy use in determining the overall environmental impact. In addition, location-dependent factors, such as the type of electricity generation (coal, nuclear, water), distance from manufacturing location, etc. change the environmental impact assessment depending on where products are made and where they are used.

There are currently at least two sources of environment-related data for products available to consumers. The first source is government-provided data, such as that provided by the Environmental Protection Agency's EnergyStar program, which is a U.S. government-based voluntary manufacturer labeling system that rates the energy usage of products. The EnergyStar program suffers from several drawbacks, including:

1) One dimensional focus on energy usage by the product in consumer hands. Although energy is a factor in the environmental impact of many product categories, there are others that both environmental scientists and consumers are concerned about that are not addressed by EnergyStar.

2) Slow speed of product category coverage. Over 19 years, EnergyStar has energy efficiency standards for only 50 product categories of the 1000s in the marketplace.

3) Energy usage data is supplied voluntarily by manufacturers, and the data is not adequately audited by the government to confirm that products meet the manufacturer's claimed specifications.

4) EnergyStar applies a national average for energy (electricity) cost calculations, instead of using accurate, actual local energy costs.

5) EnergyStar does not consider the geographical aspects of energy production and product use, which affect the contribution to global warming, natural resource depletion, environmental toxicity and other adverse human health consequences.

A second source of environment-related data for products available to consumers is public information provided by manufacturers. Some websites, such as “www.goodguide.com” (see U.S. Pat. Appl. Publ. 2008/0086387 of Dara O'Rourke et al.) and “www.ecorate.com” combine public information provided by manufacturers with generic public information about a product category to rate a product. For example, goodguide.com and ecorate.com use publicly available information from manufacturers and various databases to analyze and score the environmental, social, and health impact of products. An acknowledged problem with this approach is the heavy reliance on manufacturer-provided information about the products themselves to inform product comparison decisions, as it has often been shown that manufacturer claims are often unsupported, exaggerated, and insufficiently disclosed. This leaves these systems open to serious questions about the accuracy and appropriateness of the inputs they rely on, and consequently, the ratings that they generate.

There are also sources of data that are not widely available to consumers. For example, life cycle assessment (LCA) tools currently exist for assessing some of the environmental impacts caused by manufactured products. Many of these tools are based on methods defined by the International Organization for Standardization (ISO) 14040-14044 standards (ISO 14040 2006; ISO 14044 2006). LCA tools are employed practically exclusively by specially trained academics, specialist consultants and corporations, but performing a full lifecycle analysis on a product is an expensive and time consuming process, even for a corporation. For example, a full LCA analysis at the single company product level can take 3-6 months of effort. Consequently, as yet, few manufacturers routinely employ LCA, and those that do typically do not make the results available to the public, as there is no mandatory reporting structure for these efforts. Moreover, because there are many LCA methodologies, practitioners, and ways to report results, it is difficult to compare results across similar products by different manufacturers even if results were made available. Consequently, consumers cannot access the information today and would not likely understand or be able to use the information comparatively across products by different manufacturers in the same category if they could.

Accordingly, it is desirable to develop a product environmental rating system that has sufficient environmental attributes to characterize the full impact of products in a large number of product categories over the products' entire life cycle, with enough sensitivity to address the newly emerging consumer desire to understand and act based on small but meaningful environmental-impact differences between products. In addition, it is desirable to deploy systems and methods that allow for the mass screening of products and categories across multiple environmental attributes and to cover the entire environmental impact of the product lifecycle using a common methodology that does not heavily rely on data supplied by product manufacturers.

### SUMMARY OF THE INVENTION

Embodiments of systems and methods consistent with the principles of the present disclosure test a product empirically in a testing laboratory to discover measurable facts about the product's environmental impact independent of manufacturer-provided data about the product. Embodiments also gather data on likely product use by users in the marketplace and gather information describing the processes and stages in the product's life cycle. Embodiments combine the laboratory-generated facts and data, the end-user usage and product data from research, and the life cycle data to produce an information label, report, rating or score for the product that reflects the product's environmental impact. In some embodiments, the rating or score may be based on comparisons to similar products.

In accordance with embodiments of the invention, systems and methods for assessing a product are provided that test the product to produce a set of operating characteristics, test the product to produce a set of materials characteristics, collect information from users of the product to produce a set of usage characteristics, perform a life cycle analysis of the product based on the set of operating characteristics, the set of materials characteristics, and the set of usage characteristics to produce a set of results representing an environmental impact of the product, and display the set of results representing an environmental impact of the product. Various embodiments also research the product to produce a set of product characteristics and use the set of product characteristics in the lifecycle analysis.

In one embodiment consistent with the invention, systems and methods are provided for receiving a set of operating characteristics produced by testing the product, receiving a set of materials characteristics produced by testing the product, receiving a set of product usage and research characteristics produced by collecting information from users and research of the product, analyzing the life cycle of the product based on the set of operating characteristics, the set of materials characteristics, and the set of product usage and research characteristics to produce a set of results representing an environmental impact of the product, and displaying the set of results representing an environmental impact of the product.

In another embodiment consistent with the invention, systems and methods related to assessing the environmental impact of a product are provided for performing operations comprising receiving data representing operating characteristics of the product, receiving data representing materials characteristics of the product, wherein the materials characteristics of the product are determined by empirical testing, receiving data representing usage and other researched characteristics of the product, wherein the usage characteristics of the product are determined by users and research of the product, assessing, using the computing system, the environmental impact of the product over a life cycle of the product, wherein the assessing is based on the data representing operating characteristics of the product, the data representing materials characteristics of the product, and the data representing usage and researched characteristics of the product, and displaying a result assessing the environmental impact of the product over the life cycle of the product.

In yet other embodiments consistent with the invention, systems and methods are provided wherein the set of materials characteristics lacks information obtained from the manufacturer of the product; wherein the set of usage characteristics includes data specifying a geographic location of a user of the product; wherein performing the life cycle analysis comprises performing the life cycle analysis with consideration of the geographic location of both the manufacturers and users of the product; wherein testing the product to produce the set of materials characteristics comprises disassembling the product into components, classifying the components into a plurality of material types, determining a weight of components for each material type in the plurality of material types, and providing data representing the weight of components for each material type to the life cycle analysis; and wherein the set of materials characteristics comprises data representing materials composing the product and data representing materials composing the product.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a block diagram of an exemplary system that is consistent with embodiments of the invention;

FIG. 2 illustrates an exemplary label that displays a product's environmental impact, consistent with embodiments of the invention;

FIG. 3 is a flow chart of an exemplary process for laboratory testing of a product, consistent with embodiments of the invention;

FIG. 4 is a flow chart of an exemplary process for obtaining life cycle data related to a product, consistent with embodiments of the invention;

FIG. 5 is a flow chart of an exemplary process for obtaining end-user usage data and other research data related to a product, consistent with embodiments of the invention;

FIG. 6 is a flow chart of an exemplary process for analyzing the environmental impact of a product, consistent with embodiments of the invention;

FIG. 7 is a data flow diagram of an exemplary energy use analysis, consistent with embodiments of the invention;

FIG. 8 is a data flow diagram of an exemplary material content analysis, consistent with embodiments of the invention;

FIG. 9 is a data flow diagram of an exemplary user comfort and safety analysis, consistent with embodiments of the invention;

FIG. 10 is a data flow diagram of an exemplary recyclability and end-of-life analysis, consistent with embodiments of the invention;

FIG. 11 is a flow chart of an exemplary process for performing life cycle analysis with respect to the environmental impact of a product, consistent with embodiments of the invention;

FIG. 12 is a data flow diagram for an exemplary material production life cycle analysis model for a product, consistent with embodiments of the invention;

FIG. 13 is a data flow diagram for an exemplary transportation life cycle analysis model for a product, consistent with embodiments of the invention;

FIG. 14 is a data flow diagram for an exemplary manufacturing life cycle analysis model for a product, consistent with embodiments of the invention;

FIG. 15 is a data flow diagram for an exemplary product usage life cycle analysis model for a product, consistent with embodiments of the invention;

FIG. 16 is a data flow diagram for an exemplary end-of-life life cycle analysis model for a product, consistent with embodiments of the invention;

FIG. 17 is a data flow diagram for an exemplary life cycle impact assessment reporting component, consistent with embodiments of the invention; and

FIG. 18 is a block diagram of an exemplary computing system that may be used to implement embodiments consistent with the invention.

### DESCRIPTION OF THE EMBODIMENTS

Reference will now be made in detail to exemplary embodiments of the invention, examples of which are illustrated in the accompanying drawings. Wherever convenient, the same reference numbers will be used throughout the drawings to refer to the same or like parts.

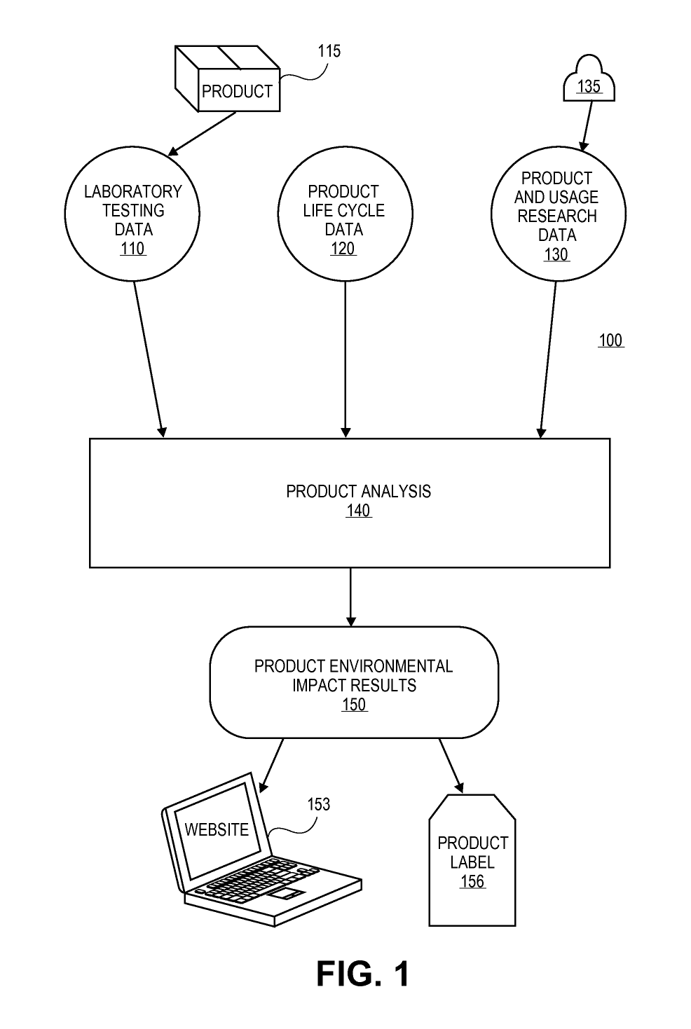

FIG. 1 is a block diagram of an exemplary product assessment system that is consistent with embodiments of the invention. In the embodiment shown, system 100 includes a product analysis module 140 that receives three inputs: laboratory testing data 110, product life cycle data 120, and product and usage research data 130. Product analysis module 140 applies an assessment algorithm to the laboratory testing data 110, product life cycle data 120, and product and usage research data 130, in combination, to produce product environmental impact results 150. A potential purchaser of a product may refer to the product environmental impact results 150 to assist in making a buying decision for the product. For example, a potential purchaser may compare the product environmental impact results 150 of one brand of product to the product environmental impact results 150 of another brand of the same type of product, and decide to purchase the more environmentally friendly brand.

In various embodiments consistent with the invention, laboratory testing data 110 comprises data obtained by empirically testing a product in a laboratory, for example in a non-partisan laboratory, such as a laboratory that is not commercially associated with any manufacturer, distributor, vendor, etc. that profits from the product. As shown, laboratory testing data 110 may be obtained by testing a product 115. Product 115 may be almost any type of manufactured product, including home appliances, home and personal electronics, computers, home and garden products, toys, business and factory machinery, cars, etc.

Examples of the types of data that may be determined by a laboratory and included in laboratory testing data 110 include data describing the operating characteristics of the product and data describing the materials characteristics of the product (e.g., the types of materials that make up the product and its packaging, and the amounts of each type). Specific examples include: data describing the size and weight of the product 115; data describing the size and weight of the product's packaging; data describing the weight and proportion of renewable materials in the product 115 and packaging; data describing the weight and proportion of sustainably harvested materials in the product 115 and packaging; data describing the weight and proportion of recycled materials in the product 115 and packaging; data describing the heat emissions of the product 115 during operation (e.g., BTU per usage cycle); data describing the hot spots on the product 115 during operation (e.g., product surface temperature points with potential for skin burn during usage); data describing the electromagnetic field (EMF) generated by the product 115 (e.g., EMF in mW/cm2); data describing the noise produced by the operating product 115 (e.g., in dBA); data describing any toxins in the materials that make up the product 115 (e.g., the type and concentration with respect to regulatory/industry standards); data describing any ozone depleting chemicals in the product 115 (e.g., type and concentration with respect to regulatory/industry standards); data describing the recyclable materials in the product 115 and packaging (e.g., by weight and type); data describing the non-recyclable materials in the product 115 and packaging (e.g., by weight and type); data describing the hazardous materials in the product 115 and packaging (e.g., by weight and type); data describing the ease of disassembly of the product 115 (e.g., the time required to disassemble and separate materials for disposal); data describing the quantity and type of difficult-to-separate materials in the product 115; data describing the number of difficult-to-separate connections in the product 115; data describing the energy used by the product 115 (e.g., in kWh per mode of operation); data describing the water used by the product 115 (e.g., in gallons per hour per mode of operation); data describing any exhaust emissions of the product 115 (e.g., volume of particulate matter (PM), nitrogen oxides (NOx), nitrogen dioxides (NO2), hydrocarbons (HC), carbon monoxide (CO), sulfur oxide (SOx), etc.); data describing any fossil fuel usage by the product 115 (e.g., barrel of oil equivalents per time unit per mode), data describing the energy efficiency of the product, etc.

In various embodiments consistent with the invention, product life cycle data 120 comprises data assessing the environmental impact of a product and comprising midpoint and endpoint impacts across the entire lifespan of the product, including data obtained from a product's packaging (such as certification of the use of sustainably harvested materials), from a product's manufacturer (such as audited/certified low emission transportation methods and non toxic manufacturing techniques data), from a product's vendors (such as audited/certified low emission transportation methods), and from government and proprietary life cycle databases (such as energy mix regional impact and material recycling impact data). More specific examples of the types of data that may be included in product life cycle data 120 include data describing CO2 emissions (which may contribute to climate change) associated with manufacturing, transporting, using and recycling/disposing of the product 115 (e.g., Kg CO2e); data describing the human health impact associated with manufacturing, transporting, using and recycling/disposing of 115 (e.g., expressed as disability-adjusted life years (DALY)); data describing any ecosystem quality impact associated with manufacturing, transporting, using and recycling/disposing of 115 (e.g., expressed as PDF*M2*YR,—Potentially Disappeared Fraction of species (PDF), loss or disappearance of species over time and space. PDF·m2·yr); data describing any resource depletion associated with manufacturing, transporting, using and recycling/disposing of the product 115 (e.g., expressed as MJ—megajoules used, a unit of energy); data describing any human-toxic substances produced in association with manufacturing, transporting, using and recycling/disposing of the product 115 (e.g., kg C2H3Cl); data describing any ionizing radiation produced in association with manufacturing, transporting, using and recycling/disposing of the product 115 (e.g., Bq C-14—Carbon-14 radioactive emissions per second); data describing any ozone layer depletion associated with manufacturing , transporting, using and recycling/disposing of the product 115 (e.g., kg CFC-11); data describing any photochemical oxidation substances associated with manufacturing , transporting, using and recycling/disposing of the product 115 (e.g., kg ethylene); data describing any detrimental respiratory-effects substances (e.g., inorganics) associated with manufacturing , transporting, using and recycling/disposing of the product 115 (e.g., kg PM2.5—particulate matter below 2.5 microns); data describing any non-renewable energy use associated with manufacturing, transporting, using and recycling/disposing of the product 115 (e.g., MJ); data describing any mineral extraction associated with manufacturing, transporting, using and recycling/disposing of the product 115 (e.g., MJ); data describing any aquatic ecotoxicity associated with manufacturing , transporting, using and recycling/disposing of the product 115 (e.g., kg TEG water—Triethylene Glycol); data describing any land occupation associated with manufacturing, transporting, using and recycling/disposing of the product 115 (e.g., m2org.arable); data describing any terrestrial acidification and nitrification associated with manufacturing , transporting, using and recycling/disposing of the product 115 (e.g., kg SO2) data describing any terrestrial ecotoxicity associated with manufacturing , transporting, using and recycling/disposing of the product 115 (e.g., kg TEG soil); data describing any aquatic acidification associated with manufacturing , transporting, using and recycling/disposing of the product 115 (e.g., kg SO2); data describing any aquatic eutrophication associated with manufacturing , transporting, using and recycling/disposing of the product 115 (e.g., kg PO4 P-lim); data describing any freshwater withdrawal associated with manufacturing , transporting, using and recycling/disposing of the product 115 (e.g., WTA—fresh water to availability ratio); etc.

In various embodiments consistent with the invention, product and usage research data 130 comprises data obtained from a product's users 135, (i.e., those who purchase and/or use the product 115), from the product's vendors, e.g. retailers that sell and service the product 115, and in some cases from government reports on or private investigations of the practices of a product's manufacturer, and in some cases from the product's manufacturer. In some embodiments, portions of the product and research data 130 may be derived from information from the product manufacturer, such as information on the product packaging regarding manufacturing location, regarding whether packaging materials are made from recyclable materials, or regarding a manufacturer's take-back program, etc. More specific examples of the types of data that may be included in product and usage research data 130 include data describing serviceability of the product 115 (e.g., common replacement parts and service repair total price/new unit price, %); data describing durability of the product 115 (e.g., based on user surveys of past product duration or stress tests); data describing take-back policies and/or recycling programs for the product 115 (e.g., program's instituted by the product's manufacturer or retailer, or by a local government); data describing transport distances by mode from manufacturer (including suppliers) to end user 135 through end of life; data describing the geographic location of an end user 135 and manufacturer (including suppliers); data describing the energy mix associated with the end user's and manufacturers (including suppliers) geographic location (e.g., electricity generated by coal, hydro, nuclear, solar, wind, etc); data describing the energy cost associated with the end user's and manufacturers (including suppliers) geographic location; data describing the fossil fuel cost at the end user's geographic location; data describing the water cost at the end user's geographic location; data describing the water availability at the end user's geographic location; data describing the ground level ozone and smog formation at the end user's geographic location; data describing the end user's product usage characteristics (e.g., minutes used per year, modes of operation employed by users 135, years used); data describing the most popular products by category (e.g., best selling microwave ovens) and segment (e.g., compact, midsize, full size); data describing recyclability by material type (e.g., can a given material be recycled in US, is the recycled material the same quality as original); data describing toxics of concern to consumers, regulators and experts (e.g., obtained from consumer research, government regulations, industry associations, etc.); data describing the lifetime cost (total cost of purchasing, operating, and maintaining a product 115 over its lifetime); data describing the product manufacturer's corporate environmental responsibility (e.g., as scored from a third party evaluation, such as climatecounts.org, or in-house evaluation), etc.

One of ordinary skill will recognize that the classification of data into three categories, laboratory testing data 110, product life cycle data 120, and product and usage research data 130 is presented for conciseness and clarity of explanation. The data may be classified into different, more, or fewer categories, or reclassified among the three categories, without departing from the principles of the invention.

In some embodiments consistent with the invention, product analysis module 140 performs a series of analyses on various components of the laboratory testing data 110, product life cycle data 120, and product and usage research data 130 to generate results 150 in various categories that indicate a product's environment impact. In one embodiment, product analysis module 140 may be implemented in software executing on a computer system or processor. In other embodiments, product analysis module 140 may be implemented in hardware as a dedicated computing machine, or in a combination of software and hardware.

In one embodiment, product analysis module may generate ratings for an individual product by comparing the product's results 150 against the results for other products (not shown) in the same category. Over time, as new products are assessed, ratings automatically adjust because they are based on comparisons among products. In some embodiments, the results 150 and the ratings take into consideration end user and manufacturers (including suppliers) location.

In some embodiments, results 150 include scores in a variety of categories, which may be combined for a total product environmental store. For example, to produce a total product environmental score, product analysis module 140 may normalize and weight each rating component or category and consolidate the weighted components into a single score based on a grading curve. In some embodiments, the weights may be assigned by website users who create their own customized total product environmental score. In various embodiments, the ability for a user to customize the weights assigned to each category, or the ability to access each category rating separately, may be valuable to different users that have different concerns or interests. For example, users who are concerned about global warming may weight some categories differently from users who may be most interested in toxic materials in a product, (perhaps because they have young children at home), and apply still different weights to various categories.

The analyses performed by product analysis module 140 preferably take into account the geographic location of the user 135 and the manufacturing sites (including suppliers) of the product 115, as this allows tailoring of the results/ratings/scores by location to take into account local environmental impact factors. In one embodiment, user location may be specified by ZIP Code™ for US based users.

In the embodiment shown in FIG. 1, product analysis module 140 transforms input data 110, 120, and 130 into product environmental impact results 150 that may be presented, for example, via a product rating website 153 and/or a product label 156. Regardless of how product environmental impact results 150 are presented, the results 150 may aid purchasers in making comparisons between products. In other embodiments, product environmental impact results 150 may be used to form a product certification standard, wherein a manufacturer is certified if their product achieves specific target scores, set for each category, that indicate environmental friendliness. In still other embodiments, product environmental impact results 150 may be used to create an end-of-life management label that is used by recyclers and disposal personnel to understand the undisclosed material content of products for appropriate handling. In still other embodiments, product environmental impact results 150 can be prepared in a report for manufacturers to assess their relative strengths and weaknesses against competing products in the same category.

Various embodiments of product rating website 153 allow users to display environmental impact result information for various products, for example in the form of environmental impact ratings, scores, or assessments. In some embodiments, the product rating website 153 may allow a user to compare different brands of products in the same product category, e.g., different brands of computer monitors, to each other with respect to their environmental impact ratings or scores. In this embodiment, results and scores are regularly updated as product analysis module 140 assesses new products and results 150 are added to a database (not shown) connected to the backend of website 153. The ratings and comparisons presented on website 153 may help people better understand the environmental impact of different products in the same category and aid a user's purchase decisions. In some embodiments, product rating website 153 may be available via a mobile computing and communication device, such as a smart phone. In other embodiments, a mobile application, which performs functions similar to the those performed by product rating website 153, may execute on a mobile computing device, allowing potential users to check the environmental impact scores of products while in a store contemplating a purchase.

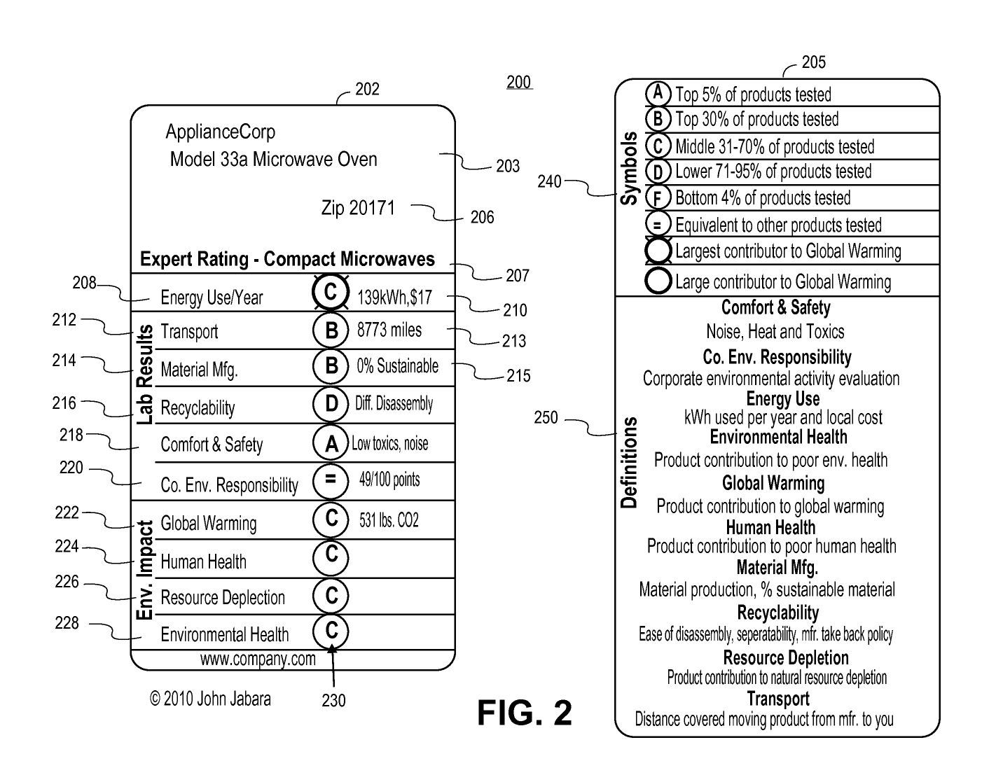

With regard to a product label 156 for conveying the results 150 of an environmental impact analysis on a product, FIG. 2 illustrates an exemplary label 200 that displays a product's environmental impact results, consistent with embodiments of the invention. In the embodiment shown, results 150 in the form of ratings information is shown on the label front 202, and explanations of symbols 240 and definitions 250 are shown on the label rear 205.

The top of the front 202 of label 200 lists a manufacturer (e.g. “ApplianceCorp”) and product model (e.g., “Model 33a Microwave Oven”) 203 of a product. The top of label 200 further lists a location 206 (e.g., ZIP™ code 20171) for which the end user ratings were generated. The top of label 200 also lists the product category 207 (e.g., “compact microwaves”) to which the product model 203 belongs.

The center section of the label front 202 shows lab results information, including ratings or scores in various categories 208-220. In the embodiment shown, the lab results rate the product in six categories: energy use per year 208, transport 212, materials and manufacturing 214, recyclability 216, comfort and safety 218, and company environmental responsibility 220. As shown, a rating 230 in each category is calculated for the product. In some embodiments, rating 230 provides an indication of the product's characteristics in comparison to other products in the same product category 207. For example, as shown in symbols explanation section 240 of the label rear 205, rating 230 may indicate that the product is in a specific percentile of the products that have been tested, such as the top 5% of products tested, middle 31-70% of products tested, or bottom 4% of product tested. In some embodiments, the symbols may be color- and/or shape-coded. For another example, the symbology associated with rating 230 may indicate the category that is the largest contributor to global warming for a particular product.

As shown, label 200 may include quantitative details (e.g., 210, 213) supporting the category rating 230. For example, as shown on exemplary label 200, the energy use quantitative detail 210 indicates that the Model 33a microwave oven, operating in ZIP code™ 20171, is expected to consume 139 kW h (kilowatt-hours) of energy per year, at a cost of $17 for the energy (in this case, electricity). Similarly, transport quantitative detail 213 indicates that the Model 33a microwave oven is transported approximately 8773 miles from the manufacturer to reach a consumer in ZIP code™ 20171.

The bottom section of the label front 202 shows environmental impact ratings or scoring categories 222-228. In the embodiment shown, the environmental impact ratings assess the product in four categories: global warming 222, human health 224, resource depletion 226, and environmental health 228. In the embodiment shown, the product is assigned a rating 230 in each category based on calculations by the product analysis module 140. In the embodiment shown, rating 230 provides an indication of the product's characteristics in comparison to other products in the same product category 207. As shown in definitions section 250 of the label rear 205, the global warming category 222 rating is produced from an analysis of the product's contribution to global warming throughout its life cycle. Similarly, the human health category 224 rating is produced from an analysis of the product's contribution to poor human health throughout its life cycle, the resource depletion category 226 rating is produced from an analysis of the product's contribution to natural resources depletion throughout its life cycle, and the environmental health category 228 rating is produced from an analysis of the product's impact on the loss or disappearance of species throughout its life cycle.

In embodiments that employ a product rating website 153, similar information may be presented on a webpage, and the information for multiple products may be displayed simultaneously for ease of comparison between products. One of ordinary skill will recognize that categories may be added to, deleted from, modified, or reordered on label 200 without departing from the scope of the invention. For example, a category rating the amount of freshwater withdrawal associated with a product's life cycle may be added to label 200 within the scope of the invention. For another example, the category rating for material and manufacturing 214 associated with a product's life cycle may be separated into two separate categories, one for material and one for manufacturing, within the scope of the invention. Other categories may be separated (i.e. comfort and safety) into individual components or other midpoints or endpoints of concern at the time may be incorporated into the rating from the laboratory data, user data, product research, operating characteristics or lifecycle data within the scope of the invention.

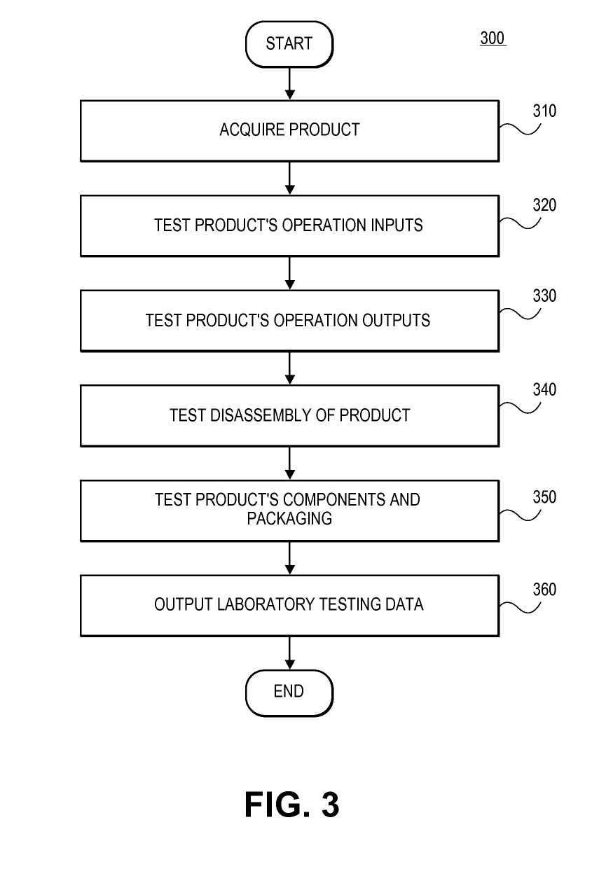

FIG. 3 is a flow chart of an exemplary process 300 for laboratory testing of a product, consistent with embodiments of the invention. In one embodiment, process 300 may be used to generate laboratory testing data 110. In the embodiment shown, process 300 begins with acquiring a product (e.g., product 115) for empirical testing and analysis (stage 310). For example, the product may be purchased from a retailer or wholesaler. Preferably, the product is acquired in its normal retail or other packaging, so that the packaging (e.g., box, plastic bags, Styrofoam™ inserts, etc.) can be tested and analyzed with the product.

At stage 320, process 300 tests the product's operation inputs. For example, laboratory technicians may test the amount of electricity, gasoline, oil, water, batteries, paper, ink, toner, or other input material, fuel, energy source, or consumable used by a product during operation.

In some embodiments, stage 320 may include testing the inputs for various operational modes of a product. For example, laboratory technicians may measure the amount of electricity consumed by a microwave oven while operating in each of its various modes, such as reheat, defrost, sensor cook, time cook, and cook at specific power levels. In various embodiments, the data collected from testing a product's operation inputs may be saved in a database or data structure.

Process 300 continues with testing the product's operation outputs (stage 330). For example, laboratory technicians may test the amount, duration, or frequency of combustion emissions, gas, noise, heat, toxins, electromagnetic fields, or radio frequency emissions produced or released by a product during operation. In some embodiments, stage 330 may include testing the outputs during various operational modes of a product. For example, laboratory technicians may measure the amount of noise, or the strength of the electromagnetic field, produced by a microwave oven while operating in each of various modes, such as reheat, defrost, cook, and cook at specific power levels. In various embodiments, the data collected from testing a product's operation outputs may be saved in a database or data structure.

At stage 340, process 300 tests the disassembly of the product. For example, laboratory technicians may disassemble the product as a recycler would, and record data regarding the ease/difficulty of disassembly, degree to which the product can be disassembled into groups of like materials, time required to disassemble, number of difficult to separate connections, etc. In various embodiments, the data collected from testing a product's disassembly may be saved in a database or data structure.

Process 300 next tests the components and packaging of the product (stage 350). For example, with regard to the materials characteristics of the product's components, laboratory technicians may determine the toxin content of external and internal components that are accessible after disassembly and weigh and determine the composition and proportion of various types of materials in the product's components, such as renewable materials, recyclable and non-recyclable materials, hazardous materials, easy to separate/disassemble materials, etc. Similarly with regard to the materials characteristics of the product's packaging, laboratory technicians may test for toxins in the packaging and weigh and determine the composition and proportion of various types of materials in the product's packaging, such as renewable materials, recyclable and non-recyclable materials, hazardous materials, etc. In some embodiments the laboratory may also weigh and measure the product with and without packaging and record basic information from the packaging, such as stated power requirements, manufacturer's warranty, manufacturing location, etc. In various embodiments, the data collected from testing a product's components and packaging may be saved in a database or data structure.

At stage 360, process 300 outputs the test data from the testing stages and ends. In one embodiment, the test data is saved in a database or data structure that serves as an input to an analysis engine, such as product analysis module 140.

One of ordinary skill will recognize that stages may be added to, deleted from, modified, or reordered in process 300 without departing from the scope of the invention. For example, stages 320 and 330 may be combined so that the product's operational characteristics, e.g., the product's operational inputs and outputs, are tested simultaneously. For another example, a stage may be added to employ predictive modeling to estimate the environmental impact of products that have not been empirically tested, but which are similar to previous product(s) made by the same manufacturer, where the predictive model is based on past data from the manufacturer's previous product(s).

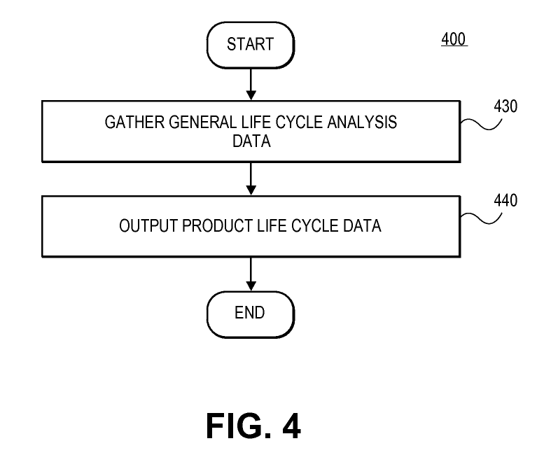

FIG. 4 is a flow chart of an exemplary process 400 for obtaining life cycle data related to a product, consistent with embodiments of the invention. In one embodiment, process 400 may be used to generate product life cycle data 120. In the embodiment shown, process 400 begins with stage 430 by gathering general life cycle analysis data for a product. For example, stage 430 may include accessing various life cycle analysis databases, which include information such as data on the production of various types of materials; data on the impact of transportation by various modes (ship, rail, truck, etc); data on end-of-life land filling and recycling processes for various materials and locations; etc. For another example, general life cycle analysis data may include data indicating materials that are of greatest concern to regulators and scientific bodies and the likely impact of those materials with respect to hazardous waste processing and storage. In various embodiments, the data gathered in this stage may be saved in a database or data structure.

At stage 440, process 400 outputs the product life cycle data from the previous stages and ends. In one embodiment, the product life cycle data is saved in a database or data structure that serves as an input to an analysis engine, such as product analysis module 140.

One of ordinary skill will recognize that stages may be added to, deleted from, modified, or reordered in process 400 without departing from the scope of the invention.

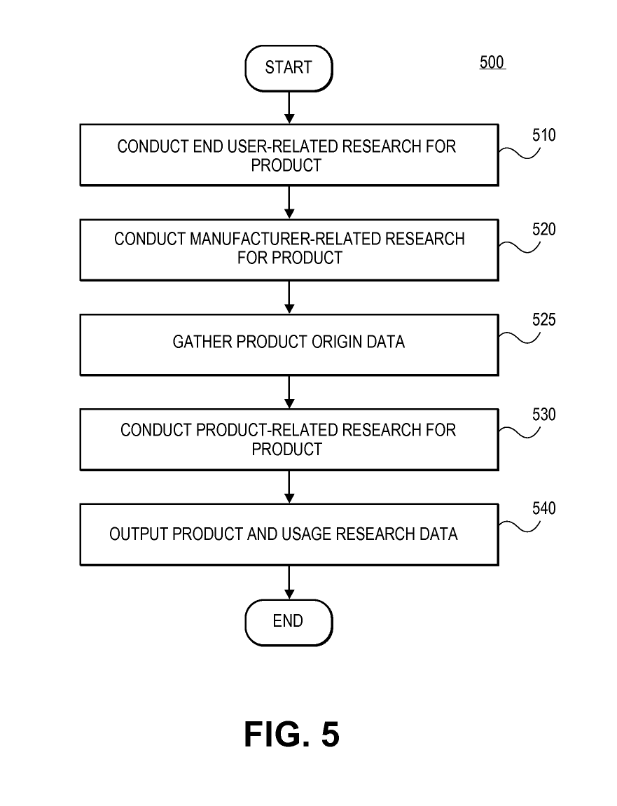

FIG. 5 is a flow chart of an exemplary process 500 for obtaining research data related to a product's market and end-user usage, consistent with embodiments of the invention. In one embodiment, process 500 may be used to generate product and usage research data 130. In the embodiment shown, process 500 begins with conducting end-user usage research related to a product (stage 510). For example, users (e.g., user 135) of a product may be emailed electronic surveys or questions, may be asked questions in person or over the telephone, or voluntarily enter information via a website in the course of conducting end-user usage research or as part of setting user-preference settings on a public access website. In one embodiment, research data regarding end-user usage of a product may be obtained from a product itself, such as a “smart” consumer appliance containing a computer that communicates its usage information from the consumer's home via the Internet without requiring action by the consumer. The usage information may be used to determine, for example, an average daily usage profile for a product in terms of, for example, minutes per day of operation in various power states or modes, an average number of days used per year, and geographic locations of users. For another example, research may be conducted, and data collected, regarding various geographic locations of users and the cost of energy use and the type of energy mix used at those locations. For another example, research may be conducted, and data collected, regarding the availability of recycling facilities for a geographic location, including the types of material that are processed, and the associated yield produced by a facility. In yet another example, a website may be provided that allows a product user to input their own personal usage parameters for a product, and these parameters may drive customized results for each particular user based on the parameters that they individually entered. In various embodiments, the data gathered in this stage may be saved in a database or data structure.

At stage 520, process 500 conducts manufacturer-related market research for the product. For example, manufacturer market research may be used to collect data regarding whether a manufacturer has a recycling program or a take-back program, and the features of the program, such as costs, incentives, availability, etc. For another example, manufacturer market research may be used to collect data regarding third party analyses and reports that evaluate a manufacturer's corporate environmental responsibility. In various embodiments, the data gathered in this stage may be saved in a database or data structure. In some embodiments, the results of the analyses and reports that evaluate a manufacturer's corporate environmental responsibility may be reported in a category 220 on label 200, using a rating 230, and the results may include quantitative data describing the rating, such as 49 out of a possible 100 corporate-responsibility points. In other embodiments, the manufacturer's corporate environmental responsibility information may be used together with other lifecycle information on material or manufacturing to estimate likely manufacturer compliance with state-of-the-art environmentally friendly manufacturing or supplier management initiatives.

At stage 525, process 500 gathers product origin data. In one embodiment, product origin data includes data regarding the product's manufacturing location and data regarding the origin locations of the components and materials that went into the product during manufacturing (e.g., the locations of the manufacturer's suppliers, and the suppliers' suppliers, etc. In embodiments wherein the locations of a manufacturer's suppliers are not available, trade statistics may be employed to extrapolate the locations of the manufacturer's suppliers. For example, if trade statistics indicate that the large majority of a certain type of product component (e.g., 3 inch by 5 inch LCD displays) that are imported into the US or manufactured for the world market come from China, then these embodiments credit China as the source of the product component. In some embodiments, product origin data may obtained by examining the product itself, and/or its packaging, for origin indicators showing where the product was manufactured, such as labels stating “made in China” or the like. In other exemplary embodiments, product origin data may be obtained from the product's manufacturer, such as by requesting the data from the manufacturer and suppliers or by searching the public information available from the manufacturer's/suppliers' websites, annual reports, press releases, etc. In various embodiments, the data gathered in this stage may be saved in a database or data structure.

Process 500 next conducts product-related market research (stage 530). For example, product-related market research may be used to identify the most popular products in a product category and sub-categories, for example, by gathering data from leading retailers (e.g., amazon.com). This data may be used to determine which products to test in a laboratory, or used to design a website 156 that presents product environmental impact results 150.

At stage 540, process 500 outputs the product and usage data from the previous stages and ends. In one embodiment, the product and usage data is saved in a database or data structure that serves as an input to an analysis engine, such as product analysis module 140.

One of ordinary skill will recognize that stages may be added to, deleted from, modified, or reordered in process 500 without departing from the scope of the invention.

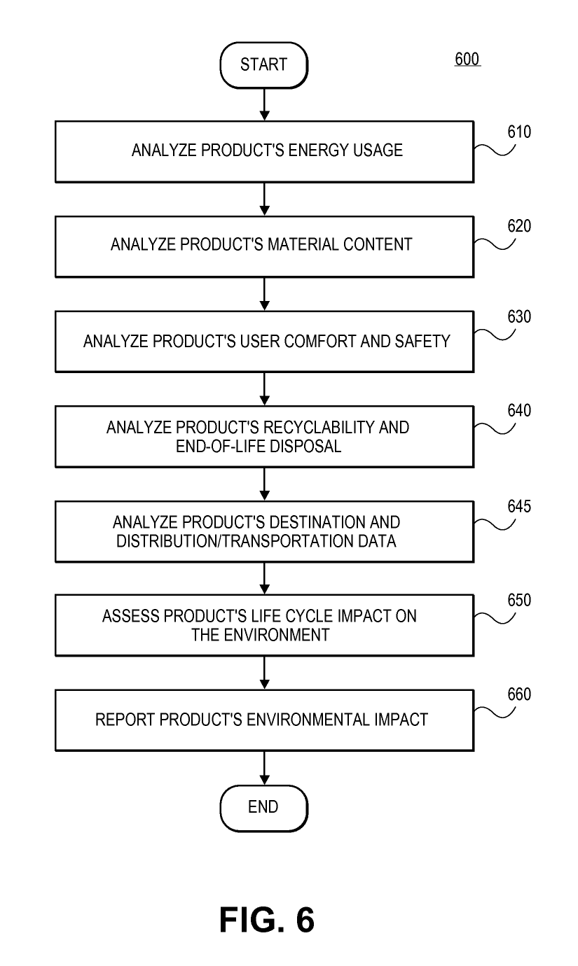

FIG. 6 is a flow chart of an exemplary process 600 for analyzing the environmental impact of a product, consistent with embodiments of the invention. In one embodiment, product analysis module 140 may be implemented using process 600 embodied as an analysis program or software analysis engine. In the embodiment shown, process 600 begins by analyzing a product's energy usage (stage 610).

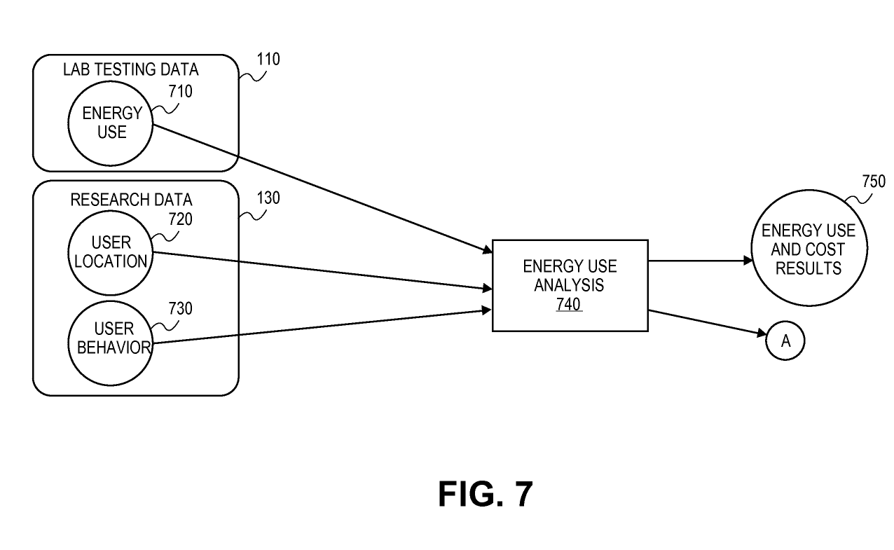

In one exemplary embodiment, energy use analysis stage 610 of process 600 may be implemented using an energy use analysis component 740, as shown in FIG. 7, which receives as input laboratory testing data 110, which includes data representing a product's measured energy use 710. In the embodiment of FIG. 7, energy use analysis component 740 also receives research data 130 as an input, including data representing a geographic location of a product user 710, and data representing user behavior 720 when operating the product (e.g., average number of minutes/hours per day using the product by usage mode). In this embodiment, energy use analysis stage 610, as implemented by energy use analysis component 740, utilizes the input data in combination to calculate the environmental impact of producing and distributing the energy used to power the product at the user location, as represented by energy use and cost results 750.

In one exemplary embodiment, energy use analysis component 740 calculates the total Kilowatt hours of electricity used per year by a product using user-behavior-research data (e.g. time per year of product usage in various operation modes) multiplied by local energy costs, to produce a localized annual electricity usage and cost results 208, 210, for the ‘Lab Results’ portion of label 200. Energy use analysis component 740 may also calculate the lifetime energy usage and lifetime energy cost results for the product by multiplying the total Kilowatt hours by the lifetime usage years of the product.

As shown by connector “A” and explained further below, these results may be input into a lifecycle analysis model, such as product use LCA model 1510, tailored to local energy mix emissions data, which calculates a lifetime toxic emissions result, fossil fuel depletion result and other environmental impact capture endpoints results like global warming, environmental toxicity, etc. In certain embodiments, these lifecycle analysis model results may be provided in the Environmental Impact portion of label 200. In various embodiments, the calculations of the lifecycle analysis model, such as product use LCA model 1510, take into account the impact of the manufacturer's and suppliers' energy use, according to their geographic location(s).

Energy use and cost results 750 may include data indicating the amount of energy used per year by the product (e.g., based on typical user behavior and measured energy use), and the cost of that energy (e.g., based on the geographic location). In certain embodiments, energy use and cost results 750 and/or a rating(s) or attribute(s) derived therefrom, may be displayed on the front side 202 of a label 200, for example in output result category 208, as shown in the example of FIG. 2. Similarly, energy use and cost results 750 and/or a rating derived therefrom, may be accessible via a public website 153.

In certain embodiments, energy use and cost results 750 and/or a rating(s) or attribute(s) derived therefrom, may be used as an input to downstream processes or components, as denoted by the “A” connector in FIG. 7 and explained further below.

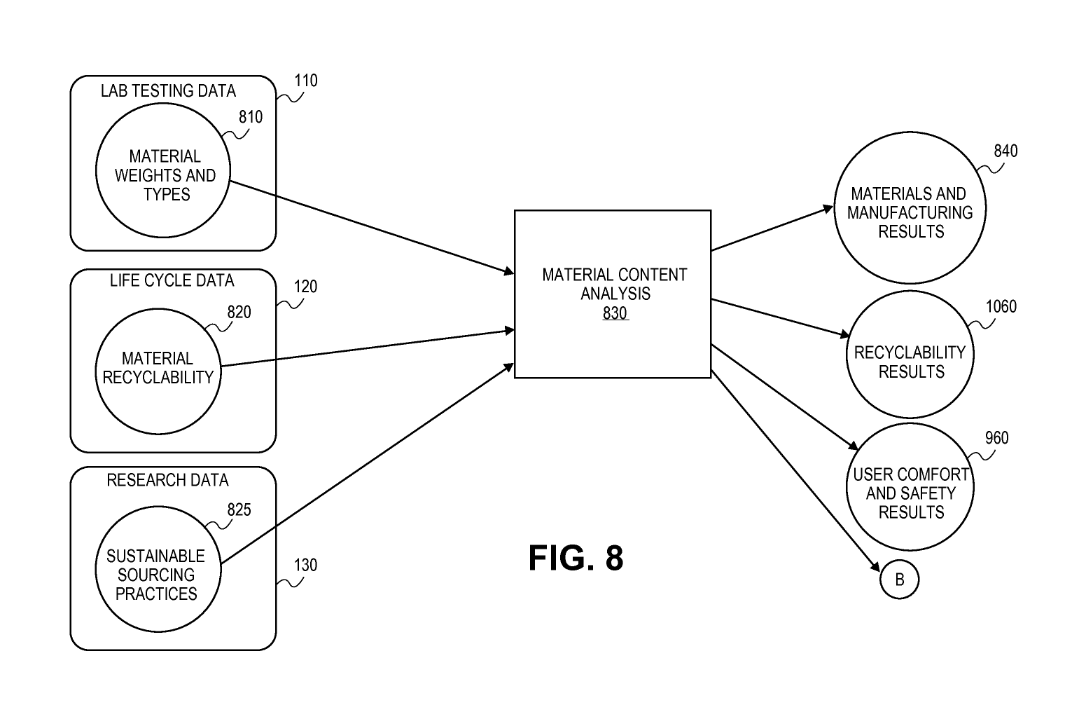

Referring again to FIG. 6, process 600 continues with analyzing a product's material content (stage 620). In one exemplary embodiment, material content analysis stage 620 of process 600 may be implemented by a material content analysis component 830, as shown in FIG. 8. Inputs to material content analysis component 830 may include laboratory testing data 110, which may include data representing the weights and types of material in a product 810. In the embodiment of FIG. 8, material content analysis component 830 may also receive life cycle data 120 and research data 130 as input, including data representing the recyclability of the materials in the product 820 and data representing the sustainable sourcing practices of the product's manufacturer 825.

In the embodiment shown, material content analysis stage 620, as implemented by material content analysis component 830, utilizes the input data in combination to calculate output results 840 assessing the materials and manufacturing processes associated with the product, results assessing the recyclability of the product 1060, and results assessing the user comfort and safety 960 associated with the product.

In some embodiments, the outputs of material content analysis component 830 may include intermediate results or intermediate attributes, which are combined with the results of other analyses to produce a product's ratings or scores. For example, material content analysis component 830 may summarize five intermediate attributes, (output data indicating the amount of non-recyclable and hazardous material, output data indicating the amount of non-recyclable and non-hazardous material, output data indicating the amount of recyclable and hazardous material, output data indicating the amount of recyclable and non-hazardous material, and output data indicating the weight of difficult to separate materials), for use in generating a recyclability rating for a product (e.g., a rating for category 216 of label 200). For another example, material content analysis component 830 may summarize two intermediate attributes, (output data indicating the proportion of renewable materials and output data indicating the proportion of sustainably harvested materials), for use in generating a material rating for a product (e.g., a rating for category 214 of label 200). For yet another example, material content analysis component 830 may provide one intermediate attribute, (output data indicating the amount of toxins below specified thresholds), for use in generating a user comfort and safety rating for a product (e.g., a rating for category 218 of label 200).

In these embodiments, results 840, 1060, and 960 and/or a rating(s) or attribute(s) derived therefrom, may be used as an input to downstream processes or components, as denoted by the “B” connector in FIG. 8 and explained further below.

For example, the results calculated by material content analysis module 830, such as results characterizing the material types and weights (including packaging) that make up a product, may be input into a life cycle analysis model, such as material production LCA model 1210, which calculates an estimate of the environmental impact of all upstream processes associated with the extraction, processing and transportation of these materials to the manufacturer. The life cycle analysis model preferably tailors the estimate based on the locations of the material manufacturer and the product's manufacturer, the energy mix used at those locations and associated environmental impacts, etc. The appropriate location inputs (e.g., country of manufacture) may be obtained from the product packaging, from the manufacturer, from the material supplier, from government trade statistics, etc. In some embodiments, the manufacturer's environmental responsibility score 220 may be used to positively or negatively weight results for a manufacturer, where a higher manufacturer's environmental responsibility score 220 indicates that a manufacturer employs relatively clean and environmentally friendly material manufacturing processes in its operations. In another embodiment, manufacturing process environmental impacts for the product can be estimated from published literature on similar products, and manufacturers can be encouraged to submit further information to improve accuracy where manufacturing impacts are a significant factor in the environmental assessment.

In certain embodiments, results 840, 1060, and 960 and/or a rating(s) or attribute(s) derived therefrom, may be displayed on the front side 202 of a label 200, for example in output result categories 214, 216, and 218, as shown in the example of FIG. 2. Similarly, results 840, 1060, and 960 and/or a rating derived therefrom, may be accessible via a public website 153.

In the embodiment shown in FIG. 2, label 200 combines materials and manufacturing into a single category 214 for convenience. In other embodiments, these two results may be presented separately. The life cycle analysis of a products materials and manufacturing may discover that a product's materials and manufacturing processes are a large, or the largest, contributor to global warming (e.g., percentage contribution to the overall carbon footprint of the product) in the product's lifecycle, which may be indicated with a specific symbol, as shown in symbols section 240. As shown in the embodiment of FIG. 2, label 200 may also present information showing the calculated amount of renewable, recycled or post consumer material content for a product 215. In one embodiment, products with high renewable, recycled, post consumer content receive higher scores that contribute to the rating 230 in category 214.

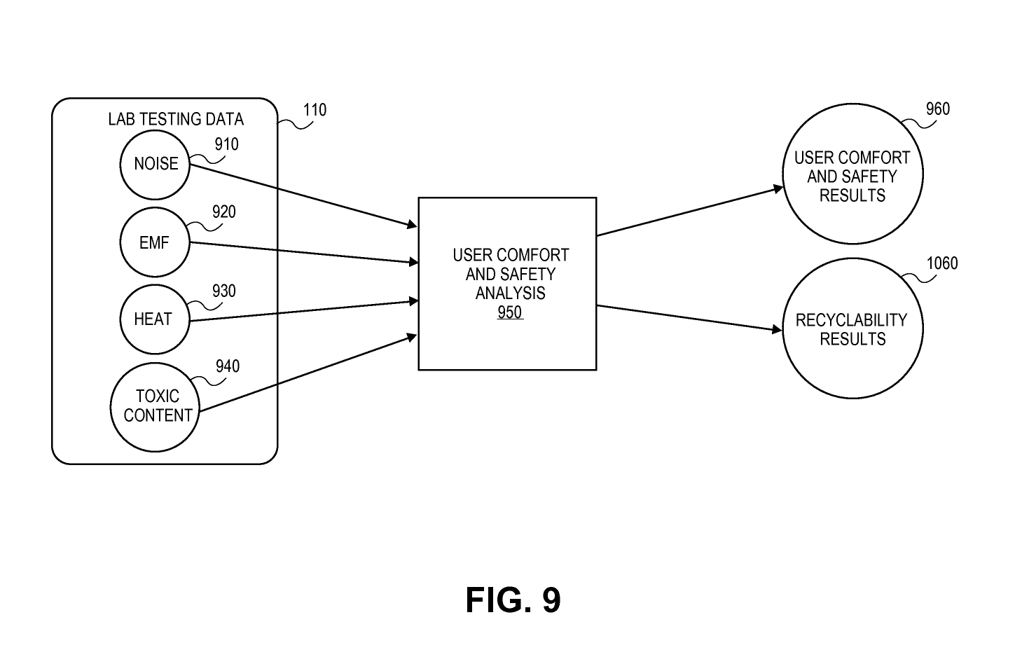

At stage 630 of FIG. 6, process 600 continues with analyzing a product's user safety and comfort. In one exemplary embodiment, safety and comfort analysis stage 630 may be implemented by a user comfort and safety analysis component 950, as shown in FIG. 9, which takes as inputs laboratory testing data 110 that includes data representing a product's measured outputs of noise 910, heat 930, and EMF 920, as well as data representing the product's toxic content 940.

In one embodiment, user comfort and safety analysis component 950 receives input data describing various attributes of a product, such as noise level, number of known toxics identified, burn risk during normal operation and EMF emissions, and calculates a numerical score for the product by normalizing the inputted attributes (e.g., converting the attribute data to a common scale for analysis, so that data on different scales from different products can be compared) to produce a numerical representation, applying a weight to the representation of each normalized attribute, and consolidating the normalized, weighted averages to form the overall numerical score for the product. In some embodiments, for example as shown in FIG. 2, the overall numerical score is compared to the overall numeric scores for similar products in the same category, to produce a letter rating 230 in the Comfort and Safety category 218, as shown on label front 202. In the embodiment shown, there is limited space on the label 200, so the rating 230 for Comfort and Safety category 218 consolidates several attribute scores. For the Model 33a Microwave Oven label 200 shown in FIG. 2, the consolidated rating of “A” indicates its overall score was in the top 5% of similar products tested.

In an embodiment employing a website 153, the score and/or rating for each product attribute may be displayed, as well as a consolidated score. In some embodiments of website 153, a website user may specify their own weighting for each product attribute to emphasize the attributes that the user feels are more important and deemphasize the attributes that the user feels are less important. A change in attribute weightings will often change the overall score and/or rating calculated for a product.

In the embodiment shown in FIG. 9, user comfort and safety analysis component 950 utilizes the input data in combination to calculate output results assessing user comfort and safety 960 associated with the product, (which may include quantitative data describing the product, such as 0% toxics, or 64 dbA of noise during operation), and output results assessing the recyclability 1060 of the product.

In some embodiments, the outputs of safety and comfort analysis stage 630, as implemented, for example, by user comfort and safety analysis component 950, may include intermediate results or intermediate attributes (e.g., the amount of heat, EMF, noise, and toxins above specified thresholds produced by a product during periods of normal operation), which are combined with the results of other analyses to produce a product's ratings or scores.

In certain embodiments, results 1060 and 960 and/or a rating(s) or attribute(s) derived therefrom, may be displayed on the front side 202 of a label 200, for example in output result categories 216 and 218, as shown in the example of FIG. 2. Similarly, results 1060 and 960 and/or a rating derived therefrom, may be accessible via a public website 153.

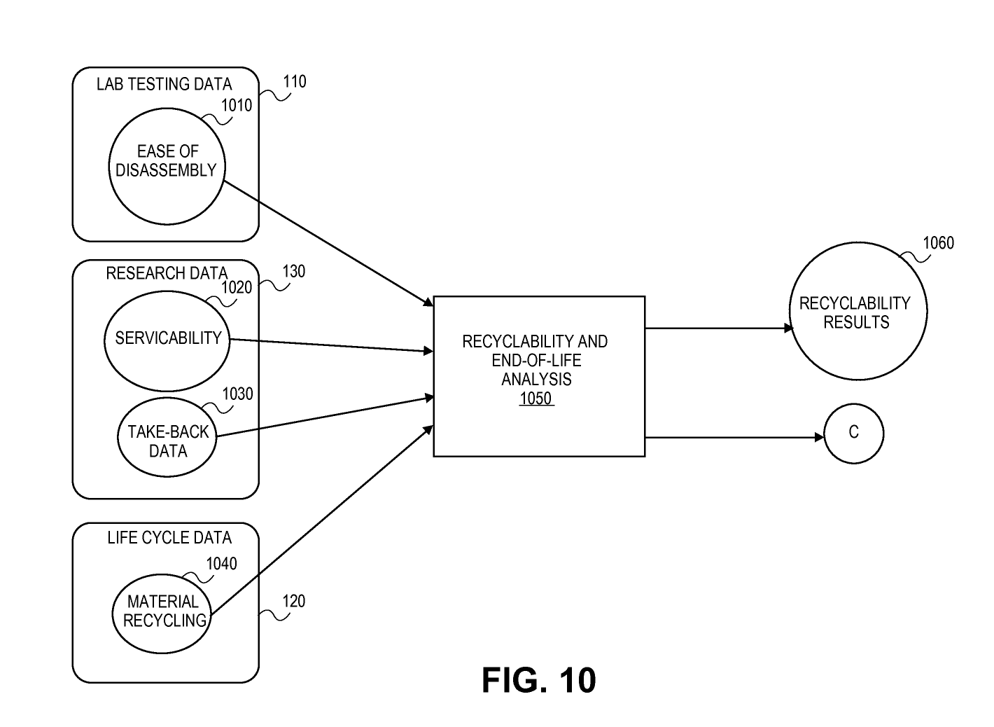

As shown at stage 640 of FIG. 6, process 600 continues by analyzing a product's recyclability and end-of-life disposal. In one exemplary embodiment, recyclability and end-of-life disposal analysis stage 640 may be implemented by a recyclability and end-of-life analysis component 1050, as shown in FIG. 10, which takes as inputs laboratory testing data 110, including data representing a product's ease of disassembly 1010 as measured by testing. Research data 130, including data representing the product's serviceability 1020 and the manufacturer's take-back policy 1030, as well as life cycle data 120 that includes material recyclability data 1040, is also input into recyclability and end-of-life analysis component 1050.

In one embodiment, recyclability and end-of-life analysis component 1050 may assess whether a product is more likely to be recycled or more likely to be discarded by calculating a recycling-likelihood factor. For example, the calculation may increase the recycling-likelihood factor based on positive data points, such as the manufacturer having a recycling program for the product, the manufacturer recycling program including positive cost incentives for consumers, the local government having a recycling program for the product/components, the local product retailers having a recycling program, a recycling program being conveniently available to consumers, the product being easily disassembled for recycling, high market values for the product's disassembled materials, etc. Conversely, the recycling-likelihood factor may be reduced for each of the preceding data points that are not present.

In the illustrated embodiment, recyclability and end-of-life analysis component 1050 utilizes the input data in combination to calculate output results assessing the recyclability 1060 associated with the product. The recyclability results 1060 may include quantitative data describing the recyclability and end-of-life processing of the product, such as data indicating the amount of time needed to disassemble the product for recycling.

In some embodiments, the outputs of recyclability and end-of-life disposal analysis stage 640, as implemented, for example, by recyclability and end-of-life analysis component 1050, may include intermediate results or intermediate attributes, which are combined with the results of other analyses to produce a product's overall ratings or scores. For example, recyclability and end-of-life analysis component 1050 may summarize three intermediate attributes, (output data indicating the potential for take-back, output data indicating an ease-of-disassembly metric, and output data indicating a material recyclability metric), for use in generating a recyclability rating for a product (e.g., a rating for category 216 of label 200). In these embodiments, results 1060 and/or a rating(s) or attribute(s) derived therefrom, may be used as an input to downstream processes or components, as denoted by the “C” connector in FIG. 10 and explained further below.

For example, as shown by connector “C” and explained further below, the results may be input into a lifecycle analysis model, such as end-of-life LCA model 1620, which identifies the amount of each material heading to each possible end-of-life processing routes (e.g., land filling, recycling, etc.) and combines the amounts with LCI data on those processing routes to represent the impact and/or benefit occurring at end of life. For processing routes where usable materials or energy result, a benefit is credited to the product that is considered equal to the impact incurred in otherwise producing those materials or energy. Transport impact at end-of-life is calculated based on material weights and distances. In various embodiments, likely end-of-life routes and transportation distances can be tailored using local geographical information.

In certain embodiments, recyclability results 1060 and/or a rating(s) or attribute(s) derived therefrom, may be displayed on the front side 202 of a label 200, for example in output result category 216, as shown in the example of FIG. 2. Similarly, recyclability results 1060 and/or a rating derived therefrom may be made accessible via a public website 153.

At stage 645, process 600 analyzes the product's destination and distribution/transportation data. In one embodiment, product destination and distribution/transportation data includes information regarding the route and conveyance used to transport the product from its place of origin (e.g., as indicated by the product origin data from stage 525) to the place where the product is sold to a consumer. For example, product destination and distribution/transportation data for a kitchen dishwasher machine may indicate that the dishwasher is manufactured in Guangdong, China, transported by rail to Shanghai, China, transported by freighter to San Francisco, Calif., transported by rail to Denver, and transported by truck to a retailer location, where it is sold to a consumer.

In some embodiments, product destination and distribution/transportation data may be obtained from manufacturers, vendors, and other entities in a product's supply chain. In some embodiments, general transportation research and models available from life cycle databases are used to find or calculate likely shipping routes, likely transportation modes (sea, land), etc. from the final assembly location to the end user location and to generate product destination and distribution/transportation data. In some embodiments, stage 645 may also include producing destination and distribution/transportation data for components and materials that go into a final product (e.g., supply chain data), such as the circuit boards, motors, pumps, sheet metal, etc. that go into a kitchen dishwasher. In various embodiments, the data produced in this stage may be saved in a database or data structure.

At stage 650, process 600 assesses a product's life cycle impact on the environment. In one embodiment, life cycle impact assessment stage 650 may be performed by a life cycle analysis engine, such as the SimaPro 7.2 software offered domestically by the Earthshift company, which has a U.S. office in Huntington, Vt. Life cycle impact assessment stage 650 preferably incorporates the effects of product manufacturing locations (including suppliers) and product use location into its analysis, as regional energy production factors and transportation factors may be significant.

In one embodiment, life cycle impact assessment stage 650 may be implemented with several LCA (life cycle assessment) models, which are computer programs or procedures that create an abstract representation of a particular aspect of a product's life cycle and/or characteristics over the product's life. Each LCA model receives inputs that represent chosen aspects, attributes, and characteristics of a product. In certain embodiments, the inputs may come from the outputs of analysis stages 610-640, and from laboratory testing data 110, life cycle data 120, and research data 130. The LCA models execute analysis algorithms, (e.g., simulation or mathematical modeling algorithms) that assess the impact of the product over its entire lifetime (e.g., from product and packaging raw material production, to delivery of materials to the manufacturer, to manufacture of the product, to distribution to consumers, to product use by consumers, to product end-of-life disposal) in terms of a set of chosen output characteristics reflecting environmental impact, human societal impact, etc., such as characteristics represented by categories 208-228 shown on label 200.

In various embodiments, life cycle impact assessment stage 650 produces a set of results indicating a product's environmental impact over its life cycle. At stage 660, process 600 reports the product's environmental impact results. In certain embodiments, the results of stages 610-650 and/or a rating(s) or attribute(s) derived therefrom, may be displayed on the front side 202 of a label 200. For example, the results of 650 may be reported in the environmental impact section of label 200, including categories 222, 224, 226, and 228, as shown in the example of FIG. 2. Similarly, stage 660 may report the results of stages 610-650, and/or a rating(s) derived therefrom, via a public website 153.

One of ordinary skill will recognize that stages may be added to, deleted from, modified, or reordered in process 600 without departing from the scope of the invention.

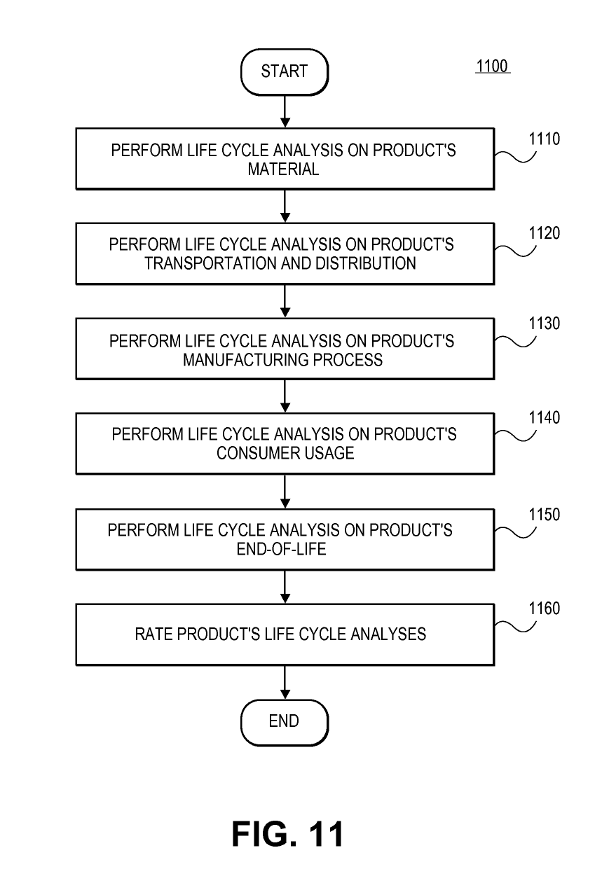

FIG. 11 is a flow chart of an exemplary process 1100 for performing life cycle analysis with respect to the environmental impact of a product, consistent with embodiments of the invention. In one embodiment, process 1100 may be used to implement stage 650 of process 600.

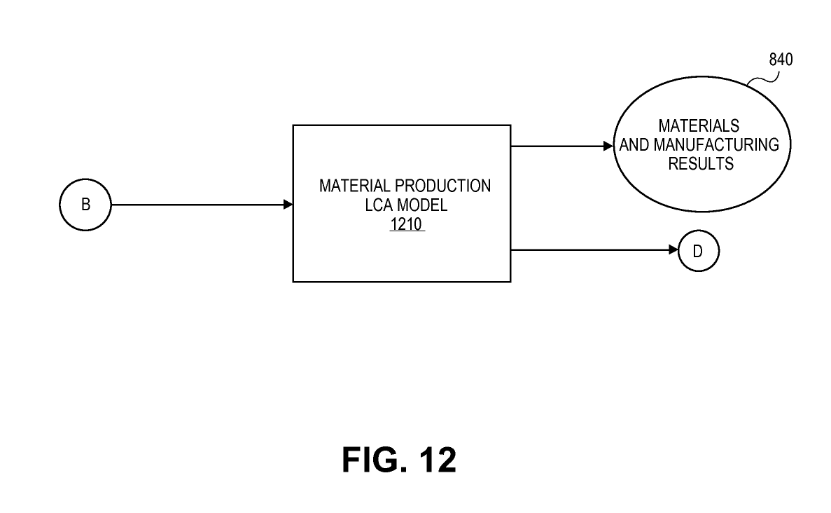

In the embodiment shown in FIG. 11, process 1100 begins by performing a life cycle analysis on a product's material (stage 1110). In one exemplary embodiment, the material life cycle analysis stage 1110 may be implemented using a material production life cycle analysis (LCA) model 1210, as shown in FIG. 12. In the embodiment shown, material production LCA model 1210 takes as input the output of the material content analysis component 830 (from FIG. 8), denoted as “B,” which includes data specifying the amounts and types of materials contained in a product.

In one embodiment, material production LCA model 1210 may process the input data “B” to calculate the environmental impact of each material used in the product, considering the material's life cycle from extraction, through production and distribution, to end of life. For example, the material production LCA model may employ an algorithm that assigns positive weighting factors to materials which have relatively low manufacturing environmental impact, and negative weighting factors to materials which have relatively high manufacturing environmental impact and then applies the weightings to the input data specifying the amounts and types of materials contained in a product to produce new data results representing the material content of that particular product. Material production LCA model 1210 may take many factors into consideration. For example, a material such as plastic is relatively cheap to produce and does not require large amount of energy to produce. Disposal of many types of plastic, however, may be difficult because it is not easily recycled or decomposed, and because it often contains toxins. Aluminum, as another example, takes a very large amount of energy to extract and produce so it is environmentally unfriendly to produce. But, aluminum is recyclable at end-of-life, although the recycling process requires significant amounts of energy. Embodiments consistent with the invention preferably employ LCA models that analyze and evaluate the full lifecycle of a material in order to understand and compare the costs and impacts of different materials.

The calculations of material production LCA model 1210 generate materials and manufacturing results 840, which may include quantitative data, such as the amount of CO2 generated in manufacturing the product. Materials and manufacturing results 840 may be used to formulate a rating or score 230 in the material and manufacturing category 214 as shown on label 200 in FIG. 2.

In some embodiments, the outputs of material production LCA model 1210, which may include intermediate results or intermediate attributes, may be used as an input to downstream processes or components, as denoted by the “D” connector in FIG. 12 and explained further below.

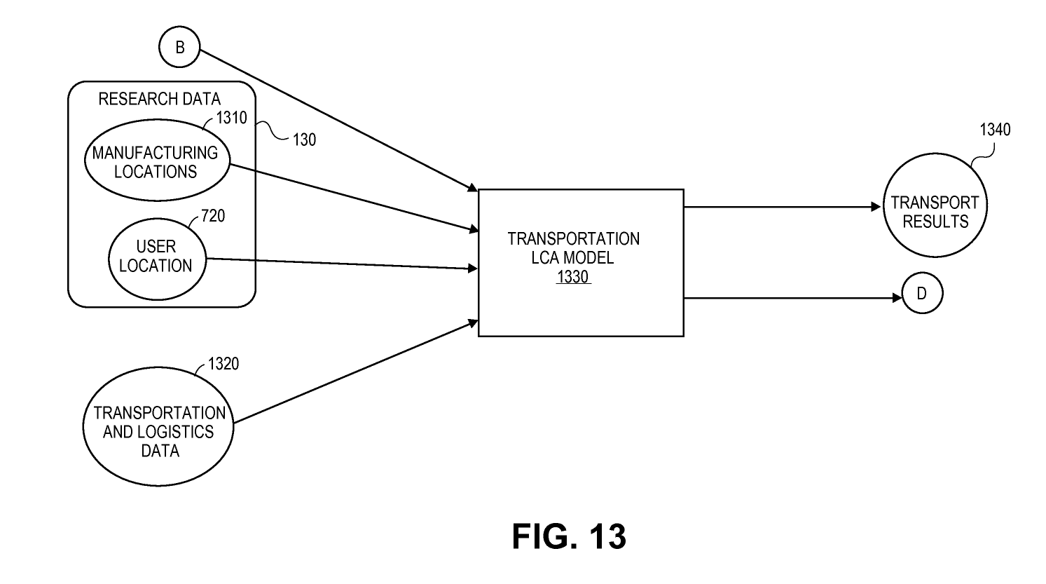

Referring again to FIG. 11, process 1100 continues by performing a life cycle analysis on a product's transportation and distribution (stage 1120). In one exemplary embodiment, the transportation and distribution analysis stage 1120 may be implemented using transportation LCA model 1330, as shown in FIG. 13. As shown, transportation LCA model 1330 takes as input the output of the material content analysis component 830 (from FIG. 8), denoted as “B,” which includes data specifying the amounts and types of materials contained in a product. Transportation LCA model 1330 also accepts as input research data 130, which may include manufacturing location data 1310 (e.g., data describing the manufacturing location(s) of a product and its components and materials) and product user location data 720, and transportation and logistics data 1320 (e.g., data indicating the probable routes and shipping modes used to transport the product and its components and materials from the manufacturer to a consumer). In some embodiments, transportation LCA model may also receive input research data indicating the actual routes and shipping modes used to transport the product and its components and materials from the manufacturer to a consumer (not shown).

In various embodiments, the transportation LCA model 1330 may process the input data in combination to calculate the environmental impact of transporting the product from the manufacturer to the end user, for example, in terms of fuel used and emissions emitted, as represented in transport results 1340. In one embodiment, the transportation LCA model 1330 may employ an algorithm that calculates the environmental impact of the transportation routes and modes used to get a product from the manufacturer to the user, based on the weight of the product (from laboratory testing data 110), distances traveled (from research data 130) and transport modes (e.g., ship, truck, air—from research data 130). For example, the algorithm produces output results such that two similar products, one made in China and the other in Canada, and both destined for Los Angeles, are assessed on the amount of fossil fuels consumed and toxic emissions resulting from the transportation of the products to the same end user. For some product categories, (e.g., heavy products, products that use low or no energy and products manufactured overseas), transportation impacts can be significant contributors to overall environmental impact.

Transport results 1340 may include calculated quantitative data, such as the number of miles 213 that the product is transported, and which contribute to a rating or score 230 in the transport category 212 as shown on label 200 in FIG. 2. In some embodiments, the outputs of transportation LCA model 1330, which may include intermediate results or intermediate attributes, may be used as an input to downstream processes or components, as denoted by the “D” connector in FIG. 13 and explained further below.

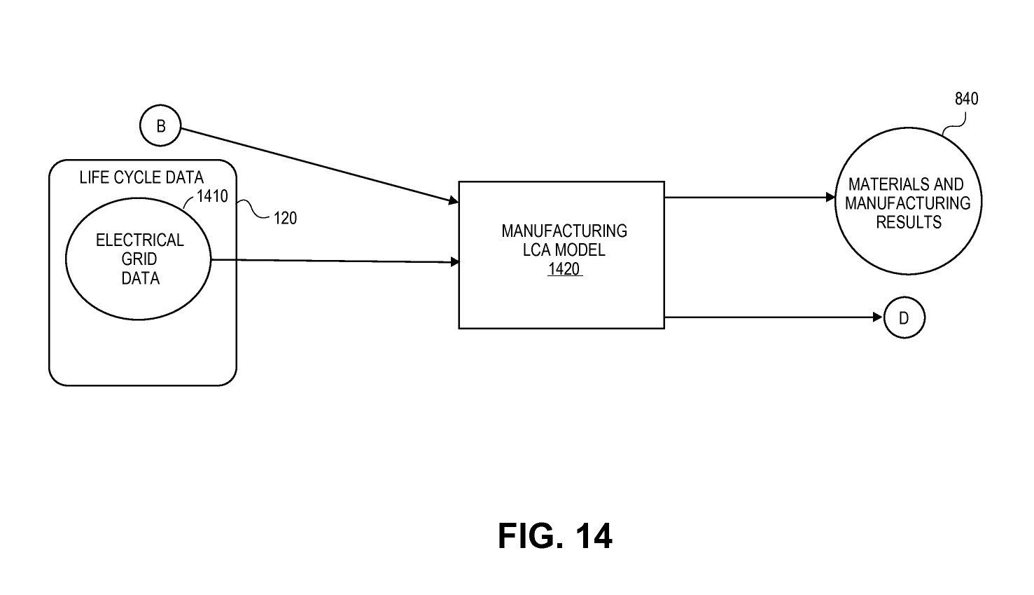

Returning to FIG. 11, stage 1130 of process 1100 performs a life cycle analysis on a product's manufacturing process. In one exemplary embodiment, the manufacturing life cycle analysis stage 1130 may be implemented using manufacturing LCA model 1420, as shown in FIG. 14. In the embodiment shown, manufacturing LCA model 1420 takes as input the output of the material content analysis component 830 (from FIG. 8), denoted as “B,” which includes data specifying the amounts and types of materials and components contained in a product. Manufacturing LCA model 1420 also receives as input life cycle data 120, which may include electrical grid data 1410 (e.g., data describing geographically how electricity is generated (e.g., coal plant, nuclear plant, etc.) and environmental factors associated with the generation).

In various embodiments, the manufacturing LCA model 1420 may process the input data in combination to generate materials and manufacturing results 840. For example, may employ an algorithm that uses the material content of the product and assumptions about resources required in conversion to final product to calculate an estimate of the environmental impact of manufacturing processes (not already covered by material production LCA model 1210) used to produce the product. In various embodiments, the manufacturing LCA model 1420 may produce representations of the total use of electricity, fuels, ancillary processing materials, and water by the product's manufacturing processes, and these representations may be tailored based on the manufacturing location's energy mix and associated environmental impacts. The manufacturing LCA model 1420 may also produce representations of the wastes and environmental emissions generated by the product's manufacturing processes. In some embodiments, the manufacturers environmental responsibility score 220 may be used to positively or negatively weight results for a manufacturing process, where a higher manufacturer's environmental responsibility score 220 indicates that a manufacturer employs relatively clean and environmentally friendly material manufacturing processes in its operations. In another embodiment, manufacturing process environmental impacts for the product can be estimated from published literature on similar products, and manufacturers can be encouraged to submit further information to improve accuracy where manufacturing impacts are a significant factor in the environmental assessment.

Materials and manufacturing results 840 may be used to form a rating or score 230 in the material and manufacturing category 214 as shown on label 200 in FIG. 2. In some embodiments, the outputs of manufacturing LCA model 1420, which may include intermediate results or intermediate attributes, may be used as an input to downstream processes or components, as denoted by the “D” connector in FIG. 14 and explained further below.

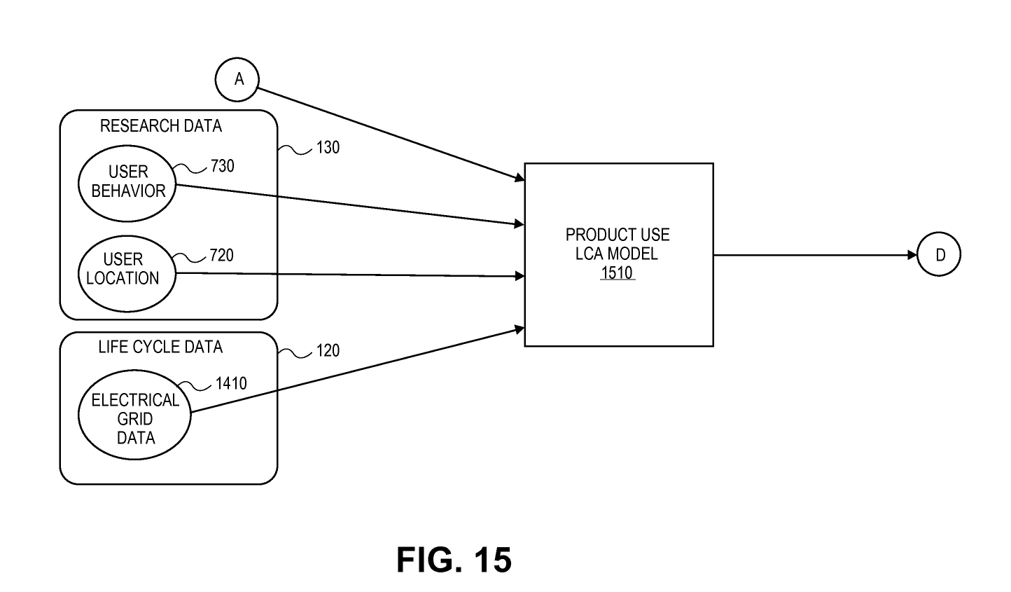

As shown in FIG. 11, stage 1140 of process 1100 performs a life cycle analysis on a product's consumer usage. In one exemplary embodiment, the consumer usage life cycle analysis stage 1140 may be implemented using product use LCA model 1510, as shown in FIG. 15. In one embodiment, product use LCA model 1510 takes as input the output of the energy use analysis component 740 (from FIG. 7), denoted as “A,” which may include, for example, data specifying the average amount of energy used per time period (e.g., year) by the product, and data specifying the cost of the energy. In the embodiment shown, product use LCA model 1510 also receives as input life cycle data 120, which may include electrical grid data 1410 (e.g., data describing geographically how electricity is generated (e.g., coal plant, nuclear plant, etc.) and environmental factors associated with the generation), as well as research data 130, which may include user behavior data 730 and user location data 720.

In various embodiments, the product use LCA model 1510 may process the input data in combination to calculate the environmental impact to the product's energy use. The resulting output data may include intermediate results or intermediate attributes, (for example, representing the effect of the energy use on global warming and fresh water depletion), that may be used as an input to downstream processes or components, as denoted by the “D” connector in FIG. 15 and explained further below. In one exemplary embodiment, the product use LCA model 1510 may employ an algorithm that uses the expected lifetime kilowatt hours of product use and the user's local electricity production mix (e.g., coal, nuclear, hydro-electric, solar) to produce a representation of the environmental impact of this locally sourced electricity, for example, in terms of fossil fuel depletion, toxic emissions, global warming and other factors and attributes.

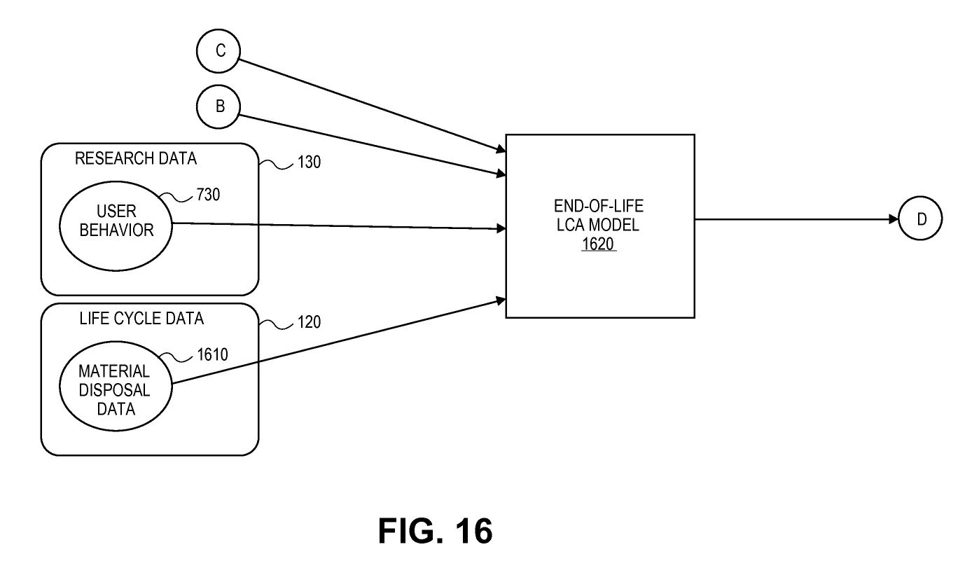

Referring again to FIG. 11, stage 1150 of process 1100 performs a life cycle analysis on a product's end-of-life processes. In one exemplary embodiment, the end-of-life life cycle analysis stage 1150 may be implemented using end-of-life LCA model 1620, as shown in FIG. 16. In this embodiment, end-of-life LCA model 1620 takes as input the output of the recyclability and end-of-life analysis component 1050 (from FIG. 10), denoted as “C,” which may include, for example, data describing a product's ease of disassembly, potential for take-back, and serviceability. As shown, end-of-life LCA model 1610 also receives as input the output of the material content analysis component 830 (from FIG. 8), denoted as “B,” which may include data specifying the amounts and types of materials contained in a product. In the embodiment shown, product use LCA model 1510 also receives as input life cycle data 120, which may include material disposal data 1610 (e.g., data describing geographically how various materials are disposed of (e.g., recycled, land fill, incinerated, etc.) and environmental factors associated with each disposal), as well as research data 130, which may include user behavior data 730.

In various embodiments, the end-of-life LCA model 1620 may process the input data in combination to generate output, which may include intermediate results or intermediate attributes, that may be used as an input to downstream processes or components, as denoted by the “D” connector in FIG. 16 and explained further below. In one exemplary embodiment, the end-of-life LCA model 1620 may employ an algorithm that identifies the amount of each material heading to each possible end-of-life processing routes (e.g., land filling, recycling, etc.) and combines the amounts with LCI data on those processing routes to represent the impact and/or benefit occurring at end of life. For processing routes where usable materials or energy result, a benefit is credited to the product that is considered equal to the impact incurred in otherwise producing those materials or energy. Transport impact at end-of-life is calculated based on material weights and distances. In various embodiments, likely end-of-life routes and transportation distances can be tailored using local geographical information.

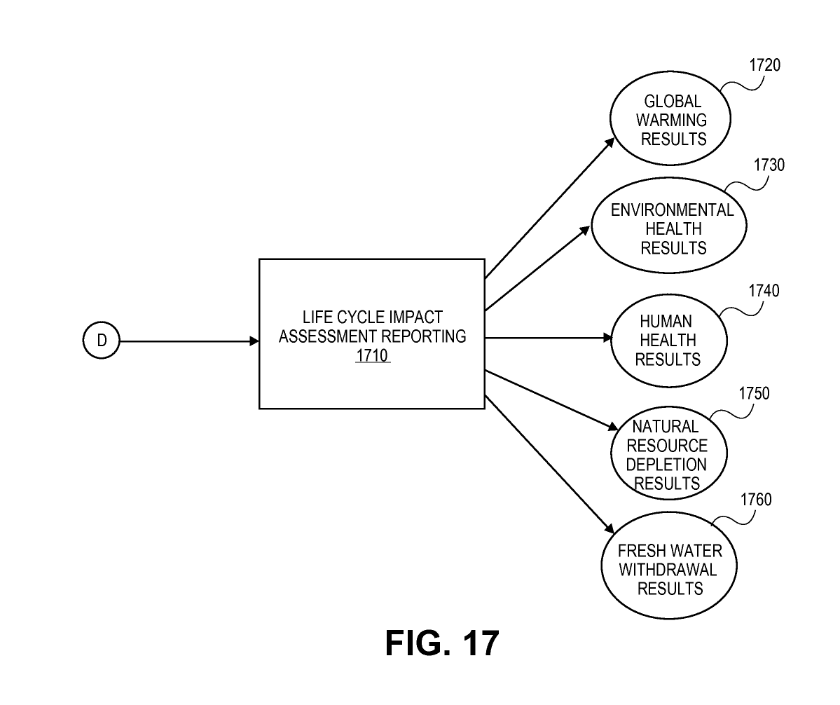

Looking again at FIG. 11, process 1100 continues to stage 1160, which rates a product based on the life cycle analyses performed in stages 1110-1150. In one exemplary embodiment, rating stage 1160 may be implemented using life cycle impact reporting component 1710, as shown in FIG. 17. In this embodiment, life cycle impact reporting component 1710 takes as inputs the outputs of material production LCA model 1210, transportation LCA model 1330, manufacturing LCA model 1420, product use LCA model 1510, and end-of-life LCA model 1620 (from FIGS. 12-16), denoted as “D.”

Life cycle impact reporting component 1710 process the inputs in combination to produce output results 1720-1760. For example, life cycle impact reporting component 1710 may implement an algorithm that consolidates the results from all the LCA models in a consistent framework to provide a clear understanding and communication of the results. An example of this framework is a “midpoint-endpoint” framework, which is recommended by the latest working groups under the UNEP-SETAC Life Cycle Initiative, the leading international framework for developing global guidance on LCA practice. In one embodiment, the framework could include a set of four “endpoint” results categories, Human Health, Ecosystem Quality, Resource Depletion and Freshwater Withdrawal. Each of these categories represents an “area of concern” or “area of protection”, and they are generally viewed as being independent of each other and not able to be further combined based solely on scientific principles. Leading to these are numerous (usually about a dozen) “midpoint” indicators, including Climate Change, which are estimates in changes to the physical or chemical properties of the environment that cause harm within one of the endpoint categories.

In one embodiment, output results 1720-1760 may be reported on a label 200 using a section devoted to environmental impact ratings. For example, as shown on label front 202 of FIG. 2, global warming results 1720 may be reported in category 222 with a rating 230 calculated by life cycle impact reporting component 1710. As shown in FIG. 2, the global warming results 1720 displayed in category 222 may include quantitative data, such as 531 tons of CO2 generated over the life cycle of the product (compared to 50 tons of CO2 generated by manufacturing the product). Similarly, environmental health results 1730 may be reported in category 228 of label 200 with a rating 230 calculated by life cycle impact reporting component 1710, human health results 1740 may be reported in category 224 of label 200 with a rating 230 calculated by life cycle impact reporting component 1710, and resource depletion results 1750 may be reported in category 226 of label 200 with a rating 230 calculated by life cycle impact reporting component 1710. In the embodiment illustrated, fresh water withdrawal results 1760 are not included on label 200, but in other embodiments they may be. In other embodiments, results 1720-1760 may be reported, displayed, or disseminated by various other means, including via a website 153.

In some embodiments, life cycle impact reporting component 1710 may produce results (not shown) in addition to results 1720-1760. For example, life cycle impact reporting component 1710 may produce data representing attributes that support product category ratings or scores included in results 1720-1760. Examples of these supporting attributes include: data representing the human toxicity attributable to the product's life cycle, data representing the ionizing radiation attributable to the product's life cycle, data representing the ozone layer depletion attributable to the product's life cycle, data representing the photochemical oxidation attributable to the product's life cycle, data representing the respiratory effects attributable to the product's life cycle, data representing the non-renewable energy use attributable to the product's life cycle, data representing the mineral extraction attributable to the product's life cycle, data representing the aquatic ecotoxicity attributable to the product's life cycle, data representing the land occupation attributable to the product's life cycle, data representing the terrestrial acidification/nitrification attributable to the product's life cycle, data representing the terrestrial ecotoxicity attributable to the product's life cycle, data representing the aquatic acidification attributable to the product's life cycle, data representing the aquatic eutrophication attributable to the product's life cycle, etc.

In some embodiments, output results 1720-1760 may be accessible to the public via a website 153 that displays environmental impact ratings for a product. In these embodiments, the supporting attributes (not shown) may be displayed in conjunction with the result(s) 1720-1760 to which they relate. In some website embodiments, life cycle impact assessment reporting component 1710 may generate a narrative for a product for any or all of the results 1720-1720, and the narrative may include quantitative output data from the analysis components 740, 830, 950, 1050 and/or the LCA models 1210, 1330, 1420, 1510, and 1620. For example, a narrative displayed in conjunction with global warming results 1720 for a microwave oven 203 may state:
Over the lifetime of this product, an estimated 560 pounds of CO2 will be generated across all phases of the product life cycle, from material extraction and manufacturing, transportation through use of the product and end of life handling. Energy consumed during the use of this microwave over its lifetime is the number one contributor to global warming, followed by materials/manufacturing. One driver for this impact is the energy mix used in the State of NC, which uses primarily coal burning plants (60%) that are particularly harsh on the environment when compared with other alternatives.

For another example, a narrative displayed in conjunction with environmental health results 1730 for a microwave oven 203 may state:
The impact of this product on the health of the environment is driven by the loss or disappearance of species as a result of unfavorable conditions due to the product impact, and in this case mainly due to manufacturing impacts. Environmental stressors are sometimes expressed in terms of Potentially Disappeared Fraction of species (PDF), loss or disappearance of species over time and space (PDF·m2·yr). The impact of this product on environmental health was estimated at the disappearance of one species for one year over 94 square meters, or about ⅕ of an acre over the product lifetime.

For yet another example, a narrative displayed in conjunction with human health results 1740 for a microwave oven 203 may state:
The impact of this product on human health has been assessed using disability-adjusted life years (DALY), a measure of overall disease burden, expressed as the number of years lost due to ill-health, disability or early death. This product generates over its lifetime of use 0.00018 DALYs, driven primarily by the impact of manufacturing this product. Assuming full impact on the US population, this product would cause 55,400 life years of disability.

For a final example, a narrative displayed in conjunction with resource depletion results 1750 for a microwave oven 203 may state:
The impact of this product on the depletion of natural resources is driven primarily by the usage phase of the life cycle, where fossil fuels are depleted to produce the energy to power the product. Natural resource depletion is measured by calculating both the energy content of fuels that are used and the additional energy that will be required in the future to obtain raw materials made scarcer through their use in this product's life cycle. It is shown in mega joules used, a unit of energy (like calories) that describes the energy required to move a one-ton vehicle at 100 mph. The mega joules depleted as a result of the use of this product over its lifetime was calculated at 4221, the equivalent of 0.53 acres of trees planted.

When stage 1160 completes, process 1100 ends for the particular product that is being evaluated. One of ordinary skill will recognize that stages may be added to, deleted from, modified, or reordered in process 1100 without departing from the scope of the invention.

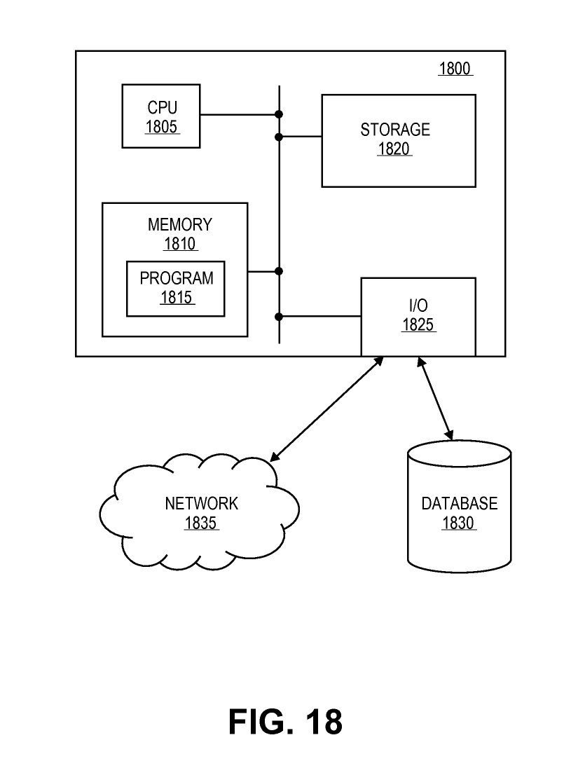

FIG. 18 is a block diagram of an exemplary computing or data processing system 1800 that may be used to implement embodiments consistent with the invention. The exact components and arrangement, however, are not critical to the invention. Computing system 1800 includes a number of components, such as a central processing unit (CPU) 1805, a memory 1810, an input/output (I/O) device(s) 1825, and a nonvolatile storage device 1820. System 1800 can be implemented in various ways. For example, an implementation as an integrated platform (such as a workstation, personal computer, laptop, etc.) may comprise CPU 1805, memory 1810, nonvolatile storage 1820, and I/O devices 1825. In such a configuration, components 1805, 1810, 1820, and 1825 may connect and communicate through a local data bus and may access a database 1830 (implemented, for example, as a separate database system) via an external I/O connection. I/O component(s) 1825 may connect to external devices through a direct communication link (e.g., a hardwired or local wifi connection), through a network, such as a local area network (LAN) or a wide area network (WAN) and/or through other suitable connections. System 1800 may be standalone or it may be a subsystem of a larger system.

CPU 1805 may be one or more known processing devices, such as a microprocessor from the Core™ 2 family manufactured by Intel™ Corporation. Memory 1810 may be one or more fast storage devices configured to store instructions and information used by CPU 1805 to perform certain functions and processes related to embodiments of the present invention. Storage 1820 may be a volatile or non-volatile, magnetic, semiconductor, tape, optical, or other type of storage device or computer-readable medium, including devices meant for long-term storage.

In the illustrated embodiment, memory 1810 contains one or more programs or subprograms 1815 loaded from storage 1820 that, when executed by CPU 1805, perform various procedures, processes, or methods consistent with the present invention. Alternatively, CPU 1805 may execute one or more programs located remotely from system 1800. For example, system 1800 may access one or more remote programs that, when executed, perform functions and processes related to embodiments of the present invention.

In one embodiment, memory 1810 may include a product analysis computer program 1815 that implements product analysis component 140 and/or process 600. Memory 1810 may also include other programs or applications that implement other methods and processes that provide ancillary functionality to product analysis component 140. For example, memory 1810 may include programs that gather, organize, store, and/or generate input data, such as laboratory testing data 110, product life cycle data 120, or product and usage research data 130, and memory 1810 may include programs that produce a product label 156 or operate a website 153 to present product environmental impact results 150. For another example, memory 1810 may include a program that implements the processes and models and components shown in FIGS. 11-17.

Methods and systems consistent with the invention are not limited to programs or computers configured to perform dedicated tasks. For example, memory 1810 may be configured with a program 1815 that performs several functions when executed by CPU 1805. For example, memory 1810 may include a single program 1815 that implements processes 600 and 1100 and the models and components shown in FIGS. 12-17.

Memory 1810 may be also be configured with other programs (not shown) unrelated to the invention and/or an operating system (not shown) that performs several functions well known in the art when executed by CPU 1805. By way of example, the operating system may be Microsoft Windows™, Unix™, Linux™, an Apple Computers™ operating system, Personal Digital Assistant operating system such as Microsoft CET™, or other operating system. The choice of operating system, and even to the use of an operating system, is not critical to the invention.

I/O device(s) 1825 may comprise one or more input/output devices that allow data to be received and/or transmitted by system 1800. For example, I/O device 1825 may include one or more input devices, such as a keyboard, touch screen, mouse, and the like, that enable data to be input from a user, such as a system operator. Further, I/O device 525 may include one or more output devices, such as a display screen, CRT monitor, LCD monitor, plasma display, printer, speaker devices, and the like, that enable data to be output or presented to a user. I/O device 1825 may also include one or more digital and/or analog communication input/output devices that allow computing system 1800 to communicate, preferably digitally, with other machines and devices. The configuration and number of input and/or output devices incorporated in I/O device 1825 are not critical to the invention.

In the embodiment shown, system 1800 is connected to a network 1835 (such as the Internet), which may in turn be connected to various systems and computing machines (not shown), such as personal computers or laptop computers of users who wish to access environmental impact data, results, and ratings for consumer products. In general, system 1800 may input data from external machines and devices and output data to external machines and devices via network 1835.

In the exemplary embodiment shown in FIG. 18, database 1830 is a standalone database external to system 1800. In other embodiments, database 1830 may be hosted by system 1800. In various embodiments, database 1830 may manage and store data used to implement systems and methods consistent with the invention. For example, database 1830 may manage and store data structures that contain laboratory testing data 110, product life cycle data 120, or product and usage research data 130, and product environmental impact result data.

Database 1830 may comprise one or more databases that store information and are accessed and/or managed through system 1800. By way of example, database 1830 may be an Oracle™ database, a Sybase™ database, or other relational database. Systems and methods consistent with the invention, however, are not limited to separate data structures or databases, or even to the use of a database or data structure.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method, implemented using a computing system, for assessing a product comprising:
testing the product to produce a set of operating characteristics;
testing the product to produce a set of materials characteristics;
collecting information from users of the product to produce a set of usage characteristics;
performing, using the computing system, a life cycle analysis of the product based on the set of operating characteristics, the set of materials characteristics, and the set of usage characteristics to produce a set of results representing an environmental impact of the product; and
displaying the set of results representing an environmental impact of the product.

2. The method of claim 1, wherein the set of operating characteristics lacks information obtained from a manufacturer of the product; and
wherein the set of materials characteristics lacks information obtained from the manufacturer of the product.

3. The method of claim 1, further comprising:
collecting information from research of the product to produce a set of product characteristics; and
wherein performing further comprises:
performing, using the computing system, a life cycle analysis of the product based on the set of operating characteristics, the set of materials characteristics, the set of usage characteristics, and the set of product characteristics, to produce a set of results representing an environmental impact of the product.

4. The method of claim 3, wherein the set of usage characteristics includes data specifying a first geographic location of a user of the product;
wherein the set of product characteristics includes data specifying a second geographic location of a manufacturer of the product and a third geographic location of a supplier of the manufacturer; and
wherein performing the life cycle analysis comprises:
performing the life cycle analysis with consideration of the first geographic location, the second geographic location, and the third geographic location.

5. The method of claim 1, wherein testing the product to produce the set of materials characteristics comprises:
disassembling the product into components;
classifying the components into a plurality of material types;
determining a weight of components for each material type in the plurality of material types; and
providing data representing the weight of components for each material type to the life cycle analysis.

6. The method of claim 1, wherein the set of materials characteristics comprises:
data representing materials composing the product; and
data representing materials composing packaging of the product.

7. The method of claim 1, wherein displaying the set of results comprises:
comparing the set of results to a set of results for a product of the same type to generate a rating for the product relative to the product of the same type; and
displaying the rating.

8. The method of claim 1, wherein displaying the set of results comprises:
printing the set of results on a label suitable for attachment to the product.

9. The method of claim 1, wherein displaying the set of results comprises:
displaying the set of results on a website that is publicly accessible.

10. A system for assessing a product comprising:
a memory containing instructions; and
a processor, operably connected to the memory, that executes the instructions to perform operations comprising:
receiving a set of operating characteristics produced by testing the product;
receiving a set of materials characteristics produced by testing the product;
receiving a set of usage characteristics produced by collecting information from users of the product;
analyzing a life cycle of the product based on the set of operating characteristics, the set of materials characteristics, and the set of usage characteristics to produce a set of results representing an environmental impact of the product; and
displaying the set of results representing an environmental impact of the product.

11. The system of claim 10, wherein the set of operating characteristics lacks information obtained from a manufacturer of the product; and
wherein the set of materials characteristics lacks information obtained from the manufacturer of the product.

12. The system of claim 10, the operations further comprising:
collecting information from research of the product to produce a set of product characteristics; and
wherein performing further comprises:
performing, using the computing system, a life cycle analysis of the product based on the set of operating characteristics, the set of materials characteristics, the set of usage characteristics, and the set of product characteristics, to produce a set of results representing an environmental impact of the product.

14. The system of claim 10, wherein the set of usage characteristics includes data specifying a first geographic location of a user of the product, a second geographic location of a manufacturer of the product, and a third geographic location of a supplier of the manufacturer; and
wherein performing the life cycle analysis comprises:
performing the life cycle analysis with consideration of the first geographic location, the second geographic location, and the third geographic location.

15. The system of claim 10, wherein the set of operating characteristics produced by testing the product comprises data produced by:
disassembling the product into components;
classifying the components into a plurality of material types;
determining a weight of components for each material type in the plurality of material types; and
providing the data representing the weight of components for each material type to the analyzing.

16. The system of claim 10, wherein displaying the set of results comprises:
comparing the set of results to a set of results for a product of the same type to generate a rating for the product relative to the product of the same type; and
displaying the rating.

17. The system of claim 10, wherein displaying the set of results comprises:
printing the set of results on a label suitable for attachment to the product.

18. The system of claim 10, wherein displaying the set of results comprises:
displaying the set of results on a website that is publicly accessible.

19. A method, implemented using a computer system, for assessing an environmental impact of a product, comprising:
receiving data representing operating characteristics of the product;
receiving data representing materials characteristics of the product, wherein the materials characteristics of the product are determined by empirical testing;
receiving data representing usage characteristics associated with the product and data representing characteristics of the product, wherein the usage characteristics of the product are determined by users of the product;
assessing, using the computing system, the environmental impact of the product over a life cycle of the product, wherein the assessing is based on the data representing operating characteristics of the product, the data representing materials characteristics of the product, the data representing usage characteristics associated with the product, and the data representing characteristics of the product; and
displaying a result of the assessing of the environmental impact of the product over the life cycle of the product.

20. The method of claim 19, wherein the data representing materials characteristics of the product comprises data representing each material that composes the product and data representing an amount of each material.

21. The method of claim 19, wherein displaying the result comprises:
comparing the result to a result for a product of the same type to generate a rating for the product relative to the product of the same type; and
displaying the rating.

22. The method of claim 19, wherein displaying the result comprises:
printing the result on a label suitable for attachment to the product.

23. The method of claim 19, wherein displaying the result comprises:
displaying the result on a website.
